(19) United States
(12) Patent Application Publication
(10) Pub. No.: US 2009/0218808 A1
(43) Pub. Date: Sep. 3, 2009

(54) IMPROVED DUCT COUPLING SYSTEM

(76) Inventor: Kenneth P. Krohn, Oceanside, CA (US)

Correspondence Address: LAW OFFICE OF KENNETH P. KROHN,;A PROFESSIONAL LAW CORPORATION, POST OFFICE BOX 4415, CARLSBAD, CA, 92018, US

(21) Appl. No.: 12/390,407

(22) Filed: Feb. 20, 2009

Related U.S. Application Data
(60) Provisional application No. 61/067,646, filed on Mar. 1, 2008.

(51) Int. Cl. F16L 55/00; B23P 19/02

(52) U.S. Cl. 285/45; 29/525

(57) ABSTRACT

The present invention relates to a device for connecting a duct (such as pipe or tubing or a container spout) having a range of shapes, sizes and thread styles to an object (such as equipment, a container, or another duct). The device may comprise an adjusting connector member, which further comprises a duct seal member that elastically changes shape to fit adjacent to the exterior surface of the duct. To hold the duct in place relative to the device, the duct seal member and the duct may be supported by a bracing member and a thread engaging member. The adjusting connector member may also be positioned within a casing member, which may further comprise components (such as a valve, coupling, and conduit connectors) that are interchangeable, along with the adjusting connector members, as part of a modular system. The invention also includes certain kits and methods of using the device.

### CROSS REFERENCES TO OTHER APPLICATIONS

This application claims the benefit of U.S. provisional application No. 61/067,646, filed on Mar. 1, 2008, which is incorporated herein by reference.

### BACKGROUND

The present invention generally relates to a device that may be used to connect to a duct (such as a length of pipe or tubing or a container spout), and in some embodiments, to an object (such as a pipe fitting, a piece of equipment, a tank or other container, or another duct), as well as kits and methods of use related to the device. More specifically, the device may be used to connect to ducts having different sizes and characteristics. In a preferred embodiment, the device acts as a coupling device to connect containers together where the containers' spouts have a range of different sizes and shapes. Thus, the coupling device may be used to transfer the contents of one container to another container without spillage.

There are coupling systems known in the relevant art that are comprised of variable connecting means designed for use with different sizes and shapes of ducts (such as pipes and tubing). In these systems, a single connector may be used to connect to ducts having a variety of different sizes and shapes within a predetermined range. For example, a single connector having variable connecting means may be used to connect to a standard garden hose, a ¾″ nominal diameter steel pipe having NPT threads, or a 1″ Type L copper pipe. Examples of these types of connectors and systems are disclosed in U.S. Nonprovisional patent application Ser. No. 11/522,607 filed on Sep. 18, 2006, Ser. No. 11/879,346 filed on Jul. 17, 2007, Ser. No. 12/012,954 filed on Feb. 6, 2008, and U.S. Provisional Patent Application No. 61/062,428 filed on Jan. 25, 2008, and Ser. No. 61/066,258, entitled MODULAR COUPLING SYSTEM filed on Feb. 19, 2008, all of which also name as inventor the inventor of the present invention. The entire disclosure of each of these patent applications is incorporated herein by this reference.

There are instances, however, where it may be desirable to connect a coupling device to a duct (such as a length of pipe or tubing or a container spout) having multiple sizes, thread types, or compositions (such as steel, plastic or copper) in circumstances where thrust loads tending to blow the duct out from the coupling device are relatively small. In these circumstances, it may also be desirable to have a coupling device that is relatively simpler to operate and cheaper to manufacture. In addition, it may be desirable to have a coupling device that is designed more specifically for only temporary connection to ducts and objects. In such cases, it may also be desirable for the coupling device to be reusable, so that it can be used multiple times for connecting to ducts and objects having a variety of sizes and shapes. For example, the user of the coupling device may desire to fill a container with water from a garden hose. After the few seconds or minutes it takes to fill the container, both the container and the hose may be disconnected from the coupling device. It is desirable in this case that the coupling device be capable of being quickly and easily connected to and removed from the garden hose and the container. The user of the coupling device may then desire to use it to transfer the contents of one container to another container. In these cases, the containers may have different spout sizes and shapes, so that they cannot be directly connected together. For example, the user may desire to transfer milk from a milk bottle to a canteen, where the spout on the milk bottle is larger than the spout on the canteen. Again, because the connection is to be of short duration, it is desirable that the connection to and disconnection from the coupling device be quick and easy.

Further, because the reusable nature of the desired coupling device permits it to be used with ducts carrying different types of fluids, it may also be desirable that the coupling device be easily disassembled and reassembled for purposes of cleaning the coupling device. Alternatively, or in addition, the coupling device may have features that assist it in not being easily contaminated by such fluids. Further still, it may be desirable to have a coupling device that regulates the flow between the duct and the object. For example, it may be desirable to have a way to regulate the flow between the milk bottle and the canteen and to stop the flow of milk once the canteen is filled to the desired level. A coupling device having these features would be advantageous over other devices and methods that are not as flexible with respect to the variety of ducts and objects that may be connected. It would also be more advantageous over other methods and devices (such as use of a funnel) that are more difficult to use and more prone to spillage of the transferred fluid.

### SUMMARY

The present invention is directed to a device and system, as well as related kits and methods of using the device and system, which meet the needs discussed above in the Background section. As described in greater detail below, the present invention, when used for its intended purposes, has many advantages over other devices known in the art, as well as novel features that result in a new device, kits and methods of using the device that are not anticipated, rendered obvious, suggested, or even implied by any prior art devices or methods, either alone or in any combination thereof.

In a preferred embodiment of the present invention, a device is disclosed that is adapted for connecting to a duct comprising a duct open end and a duct exterior surface adjacent to the duct open end having a size and shape adapted to be variable within a predetermined range. The device is comprised of a casing member and adjustable connecting means. The adjustable connecting means may be further comprised of one or more adjusting connector members. In some embodiments, different adjusting connector members may be adapted to be connected to different ranges of sizes and shapes of ducts. In these embodiments, the adjusting connector members may be part of a modularized system of adjusting connector members, all of which may be used interchangeably in their operation with the casing member. In this preferred embodiment, the adjusting connector member is further comprised of duct sealing means, a bracing member, thread engaging means, and adjusting member internal connecting means, all of which are described in more detail below. The duct sealing means may be comprised of a hollow duct seal member, which is adapted to be positioned adjacent to a portion of the duct exterior surface while the duct is connected to the duct seal member. The duct seal member may also be comprised of an inlet seal flange portion, an outlet seal flange portion, and a seal sheath portion extending between them that is shaped approximately as an hourglass (a portion of which is also approximately shaped as a hyperboloid). The bracing member supports the duct sealing means (described in more detail below) in operation of the device. In this preferred embodiment, the bracing member is approximately tubular in shape and has an inlet open end and an outlet open end. The duct seal member is positioned within the bracing member with the inlet seal flange portion positioned approximately adjacent to the open end of the bracing member. The positioning is “approximate” because other members, such as a portion of the thread engaging means, may be positioned between them. The adjusting member internal connecting means (described in more detail below) are for operatively connecting (which includes both removably or permanently connecting) the duct seal member, the bracing member, and the thread engaging member together. In some embodiments, the adjusting member internal connecting means may be comprised of an adhesive, adhesive tape, glue or epoxy, so that the volume between the duct seal member and the bracing member is sealed from the outside environment. In some embodiments, a compressible insert (described in more detail below) may be positioned in this volume between the duct seal member and the bracing member. Also in this preferred embodiment, the adjusting connector member is further comprised of thread engaging means (described in more detail below), at least a portion of which are positioned between the duct and the duct seal member while the duct is connected to the device. The thread engaging means are adapted for engaging any threads on the duct, as described in more detail below.

In this embodiment, the casing member is further comprised of casing connecting means, which are described in more detail below, adapted for connecting the casing member to the adjusting connector member. The casing connecting means may also be adapted to be connected to at least one additional adjusting connector member, so that the adjusting connector member is interchangeable with the at least one additional adjusting connector member in its operation with the casing member. The casing member may also be comprised of object connecting means, which are adapted to connect the casing member to an object, as described in more detail below. In another embodiment, the casing member is comprised of a case body, a case cap, and case cap connecting means, which are described in more detail below. The case body has a casing interior space and at least one case body open end adjoining the casing interior space. The case cap has a connector opening, which is adapted to receive the duct when it is connected to the device. The case cap connecting means removably or permanently connect the case cap to the case body at the case body open end, as described in more detail below. In these embodiments, the adjusting connector member may be adapted to be positioned approximately within the case body opening while the case cap is connected to the case body. In some of these embodiments, the case cap connecting means are comprised of a threaded portion on the case body adjacent to the at least one case body open end and a threaded portion on an opening of the case cap, so that the case cap is adapted to be screwed down onto the case body. In other embodiments of the present invention, the casing member is further comprised of a case body conduit section, a case body connecting section, case body section connecting means for operatively connecting the at least one case body conduit section to the case body connecting section (which are described in more detail below), and casing connecting means for connecting the at least one case body conduit section to an adjustable connector member. The case body connecting means may also comprise flow regulating mechanisms in some embodiments. In these embodiments, the case body section connecting means are adapted to connect at least one additional case body connecting section to the at least one case body conduit section and at least one additional case body conduit section to the case body connecting section so that all of such sections and additional sections are interchangeable as part of a modularized system. Generally, a method of using the device comprises connecting the at least one adjusting connector member to the casing member using the casing connecting means. Another method comprises operatively inserting the duct into the device. The present invention also includes a kit comprising the casing member and the at least one adjusting connector member, as well as a kit comprising the at least one adjusting connector member and the at least one additional adjusting connector member.

Thus, if the user of the system desires to connect two containers having different spout sizes together so that fluid may be transferred from one container to another, the user may unscrew the case cap from one end of the case body, place an adjusting connector member adapted to receive the size of one container spout in the case body open end, and then screw the case cap down onto the open end until the adjusting connector member is sealed between them. The user may then unscrew the case cap from the other end of the casing member, place another modular adjusting connector member adapted to receive the size of the other spout in the open end, and then screw the cap down onto the end until the adjusting connector member is sealed between them. The user may then connect each of the spouts to the device in the manner described in more detail below. Once the user has finished using the device, the spouts may be removed. The adjusting connector member and the casing member may then each be disassembled for cleaning and then reassembled for another use of the device. It is to be noted that this summary does not describe other embodiments of the present invention, which are described in more detail below.

In another embodiment of the present invention, the device may comprise a duct seal member, at least a portion of which is adapted to be positioned adjacent to a portion of the duct exterior surface, and thread engaging means adapted for drawing the duct down into the duct seal member by engaging any threads on the duct exterior surface, as described in more detail below. At least a portion of the thread engaging means may be positioned between the duct and the duct seal member while the duct is operatively connected to the device. In yet another embodiment, the device may comprise an adjusting connector member and casing connecting means for operatively connecting the adjusting connector member to a casing member, as described in more detail below. In this embodiment, the adjusting connector member is further comprised of a duct seal member, a bracing member, and adjusting member internal connecting means for operatively connecting the duct seal member to the bracing member, as described in more detail below. The duct seal member may be further comprised of an inlet seal flange portion and a seal sheath portion, which extends from the inlet seal flange portion and is shaped approximately as an hourglass. The devices of these two embodiments may also further comprise the casing member. In still another embodiment, the device comprises a casing member, a plurality of duct support members, adjustable connecting means, and casing connecting means, all of which are described in more detail below. The casing member may have a casing interior space and comprise at least one open end in fluid communication with the casing interior space. In this embodiment, the plurality of duct support members extend away from the casing member and are adapted for holding the duct in place relative to the casing member. The adjustable connecting means are adapted for connecting to a duct, and the casing connecting means are for connecting the adjustable connecting means to the casing member at the at least one open end, all as described in more detail below. In all of such embodiments, the duct may typically comprise a duct open end and a duct exterior surface adjacent to the duct open end, wherein the duct exterior surface has a size and shape adapted to be variable within a predetermined range, so that the adjustable connecting or adjusting connector member are adapted to be operatively connected to ducts within the predetermined range.

Therefore, the coupling system and device of the present invention meet the requirements described above in the Background section. The coupling device has a simple, easy to use and reuse design that allows its connection to ducts having multiple sizes, thread types, or compositions (such as steel, plastic or copper) in circumstances where thrust loads tending to blow the duct out from the coupling device are relatively small. In addition, the coupling device is designed more specifically for only temporary connection to ducts. Ducts may be quickly and easily connected to and then removed from the coupling device. The device may also be simpler to manufacture than other variable connecting means. The coupling device may also be easily disassembled and reassembled for purposes of cleaning the coupling device. In some embodiments, the coupling device may have features that assist it in not being easily contaminated by fluids transferred through the device, such as by sealing the volume between the duct seal member and the bracing member. Further still, the coupling device may regulate the flow between the duct and the object. The coupling system should also reduce spills of fluid because of the seal adapted to be formed between the duct and the device. The coupling device therefore possesses features that make it advantageous over other devices and methods that are not as flexible with respect to the variety of ducts and objects that may be connected.

There has thus been outlined, rather broadly, the more primary features of an embodiment of the present invention. There are additional features that are also included in the various embodiments of the invention that are described hereinafter and that form the subject matter of the claims appended hereto. In this respect, it is to be understood that the invention is not limited in its application to the details of construction and to the arrangements of the components set forth in the following description or illustrated in the following drawings. This invention may be embodied in the form illustrated in the accompanying drawings, but the drawings are illustrative only and changes may be made in the specific construction illustrated and described within the scope of the appended claims. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The foregoing summary, as well as the following description, will be better understood when read in conjunction with the appended drawings, in which:

FIG. 1 is a partially exploded perspective view of an embodiment of a device of the present invention, as viewed from the side of and above the device, the device generally comprising a flexible coupling with flow regulating means.

FIG. 2 is an exploded perspective view of an embodiment of a case body connecting section and case body section connecting means, as viewed from the side of and above the case body connecting section, which generally comprises a valve.

FIG. 3 is an exploded perspective view of another embodiment of a case body connecting section and case body section connecting means, as viewed from the side of and above the case body connecting section, which generally comprises orifice flow regulating means and illustrates hidden lines in phantom.

FIG. 4 is an exploded perspective view of yet another embodiment of a case body connecting section and case body section connecting means, as viewed from the side of and above the case body connecting section.

FIG. 5 is a partially exploded perspective view of an embodiment of a device of the present invention, as viewed from the side of and above the device, the device generally comprising flow regulating means.

FIG. 6 is a perspective view of an embodiment of a device of the present invention, as viewed from the side of and above the device, the device generally comprising a flexible coupling.

FIG. 7 is a perspective view of an embodiment of a case body, which is a part of the device illustrated in FIG. 6, as viewed from the side of and above the case body and illustrating hidden lines in phantom.

FIG. 8A is a perspective view of an embodiment of a case cap comprising duct holding means, as viewed from the side of and above the end of the case cap, which is adapted to be connected to a case body (not illustrated).

FIG. 8B is a perspective view of the embodiment of the case cap illustrated in FIG. 8A, as viewed from the side of and above the connector opening of the case cap.

FIG. 8C is an enlarged perspective view of an embodiment of a duct holding means support arm, which is a part of the case cap illustrated in FIG. 8A and FIG. 8B.

FIG. 9 is a perspective view of another embodiment of a case cap comprising duct holding means, as viewed from the side of and above the connector opening of the case cap.

FIG. 10 is a partially exploded perspective view of another device of the present invention, as viewed from the side of and above the device, the device generally comprising object connecting means adapted for connecting the casing member to a panel and another object.

FIG. 11A is a perspective view of an embodiment of an adjusting connector member, which is a part of the device illustrated in FIG. 1, as viewed from the side of and above the adjusting connector member, the adjusting connector member being adapted to be connected to ducts having a relatively large cross-sectional dimension.

FIG. 11B is a perspective view of the embodiment of the adjusting connector member illustrated in FIG. 11A, as viewed from the side of and above the outlet opening of the adjusting connector member, which is the end opposite of that illustrated in FIG. 11A.

FIG. 11C is an exploded perspective view of the embodiment of the adjusting connector member illustrated in FIG. 11A and FIG. 11B, as viewed from the side of and above the inlet opening of the adjusting connector member.

FIG. 12A is a perspective view of an embodiment of an adjusting connector member, which is a part of the device illustrated in FIG. 1, as viewed from the side of and above the adjusting connector member, the adjusting connector member being adapted to be connected to ducts having a relatively small cross-sectional dimension.

FIG. 12B is a perspective view of the embodiment of the adjusting connector member illustrated in FIG. 12A, as viewed from the side of and above the outlet opening of the adjusting connector member, which is the end opposite of that illustrated in FIG. 12A.

FIG. 12C is an exploded perspective view of the embodiment of the adjusting connector member illustrated in FIG. 12A and FIG. 12B, as viewed from the side of and above the inlet opening of the adjusting connector member.

FIG. 13 is a perspective view of another embodiment of an adjusting connector member, as viewed from the side of and above the adjusting connector member.

FIG. 14 is a perspective view of another embodiment of an adjusting connector member, as viewed from the side of and above the adjusting connector member.

FIG. 15A is a perspective view of another embodiment of an adjusting connector member, as viewed from the side of and above the adjusting connector member, the adjusting connector member being further comprised of a compressible insert.

FIG. 15B is a perspective view of the embodiment of the adjusting connector member illustrated in FIG. 15A, as viewed from the side of and above the outlet end of the adjusting connector member, which is the end opposite of that illustrated in FIG. 15A.

FIG. 16 is a perspective view of another embodiment of a duct seal member, as viewed from the side of and above the duct seal member, the duct seal member being further comprised of another embodiment of thread engaging means.

FIG. 17A is a perspective view of another embodiment of an adjusting connector member, as viewed from the side of and above the outlet of the adjusting connector member.

FIG. 17B is an exploded perspective view of an embodiment of a duct seal member, which is a part of the adjusting connector member illustrated in FIG. 17A, as viewed from the side of and above the inlet of the duct seal member.

FIG. 18 is an exploded perspective view of another embodiment of a device of the present invention, as viewed from the side of and above the device.

FIG. 19 is a perspective view of another embodiment of a device of the present invention, as viewed from the side of and above the device, the device being connected to a pipe and a container.

FIG. 20 is a partially exploded perspective view of another embodiment of a device of the present invention, as viewed from the side of and above the device.

### DETAILED DESCRIPTION

Reference will now be made in detail to the preferred aspects, versions and embodiments of the present invention, examples of which are illustrated in the accompanying drawings. While the invention will be described in conjunction with the preferred aspects, versions and embodiments, it is to be noted that the aspects, versions and embodiments are not intended to limit the invention to those aspects, versions and embodiments. On the contrary, the invention is intended to cover alternatives, modifications, portions and equivalents, which may be included within the spirit and scope of the invention as defined by the appended claims.

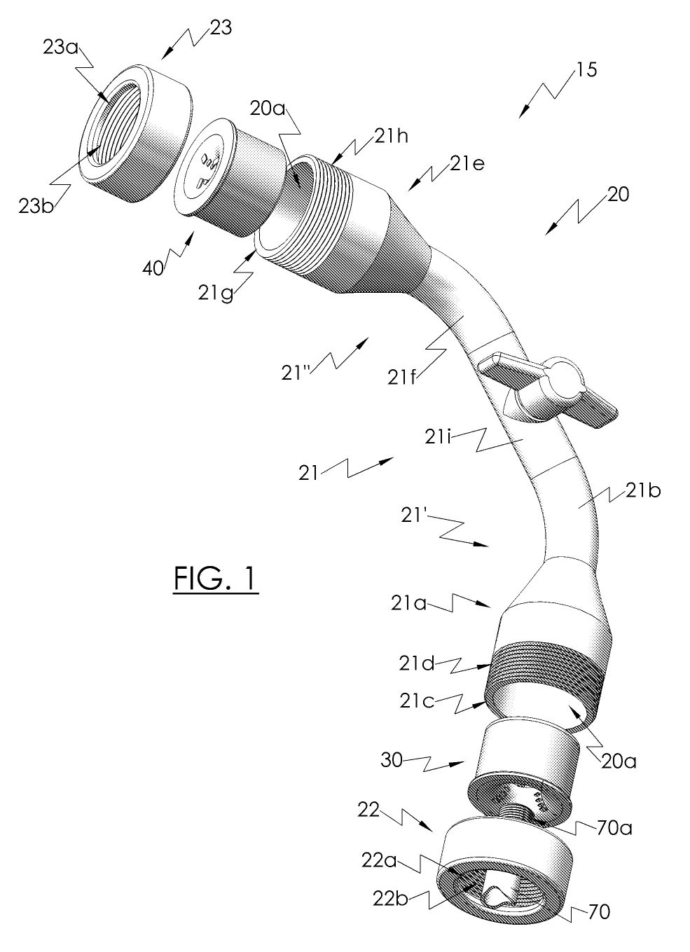

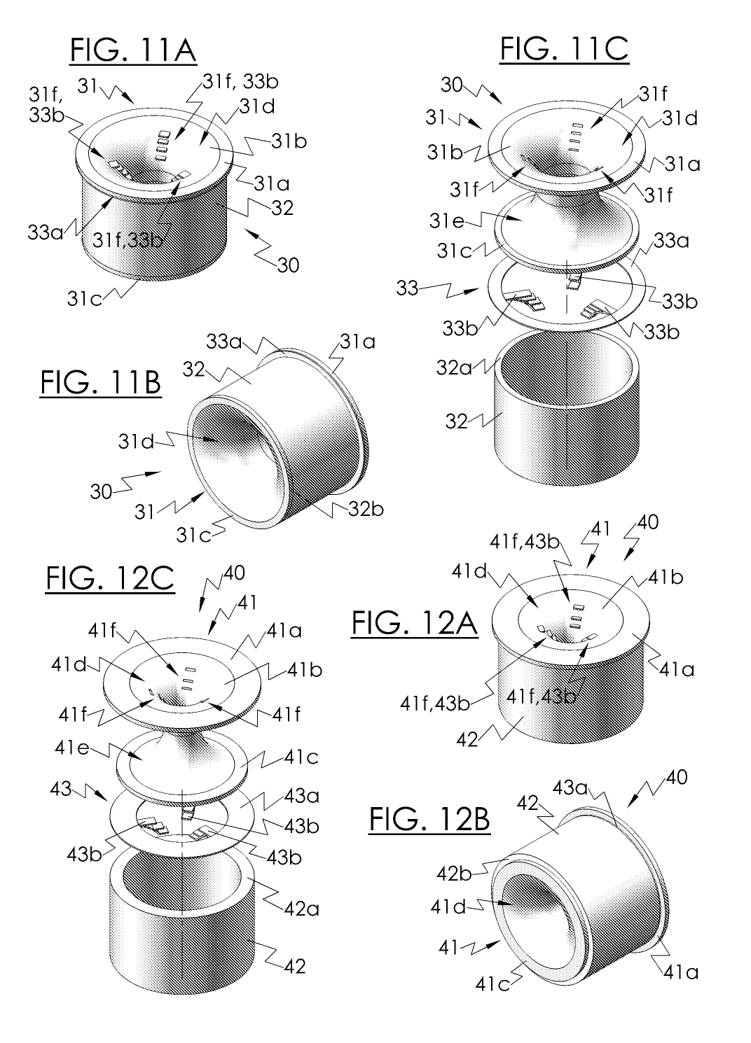

One embodiment of the present invention 15 is illustrated in FIG. 1, which presents a partially exploded perspective view of the device 15. In this illustrated embodiment of the present invention, the device 15 is comprised of a casing member 20 and adjustable connecting means (described in more detail below) that are adapted for connecting the device 15 to at least one duct (pipe 70 in the case of adjusting connector member 30, but not illustrated for adjusting connector member 40). In various embodiments, the adjustable connecting means may be comprised of at least one adjusting connector member (adjusting connector member 30 in this embodiment). The casing member 20 is further comprised of casing connecting means, which are described in more detail below, adapted for connecting the casing member 20 to the at least one adjusting connector member (adjusting connector member 30). In the illustrated embodiment, the at least one adjusting connector member (adjusting connector member 30) is further comprised of casing connecting means for connecting the at least one adjusting connector member (adjusting connector member 30) to the casing member 20. The casing member 20 is also adapted to be connected to at least one additional adjusting connector member (adjusting connector member 40 in this embodiment) that comprises the same operative casing connecting means (described in more detail below) as that comprising the at least one adjusting connector member (adjusting connector member 30). Thus, the at least one adjusting connector member (adjusting connector member 30) is interchangeable with the at least one additional adjusting connector member (adjusting connector member 40) in its operation with the casing member 20 as part of a modularized system of interchangeable adjusting connector members (adjusting connector members 30, 40). Generally, the at least one adjusting connector member (adjusting connector member 30) is capable of connecting to ducts (pipe 70) that have a different range of sizes and shapes as the range of ducts that may be connected to the at least one additional adjusting connector member (adjusting connector member 40). As is also illustrated in FIG. 11A through FIG. 11C, the at least one adjusting connector member (adjusting connector member 30) is further comprised of duct sealing means (duct seal member 31 in this embodiment), a bracing member 32, thread engaging means (thread engaging member 33 in this embodiment), adjusting member internal connecting means for operatively connecting the duct seal member 31 to the bracing member 32 and the thread engaging member 33 (an adhesive, which is not illustrated, in this embodiment), and casing connecting means for connecting the at least one adjusting connector member (adjusting connector member 30) to the casing member 20, all of which are described in more detail below. In operation of the device 15, and referring again to FIG. 1, the duct (pipe 70) is inserted into the at least one adjusting connector member (adjusting connector member 30), so that a portion of the duct seal member 31 is positioned adjacent to the exterior surface of the duct (pipe 70) around its perimeter, preferably forming a fluid-tight seal between the duct (pipe 70) and the at least one adjusting connector member (adjusting connector member 30), all as described in more detail below. As is also described in more detail below, at least a portion of the thread engaging member 33 is positioned between the duct (pipe 70) and the duct seal member 31 while the duct (pipe 70) is connected to the device 15. The thread engaging member 33 may generally serve to guide the duct (pipe 70) into the at least one adjusting connector member (adjusting connector member 30) when the duct (pipe 70) is inserted into the device 15, or it may assist in holding the duct (pipe 70) in place relative to the device 15 while the duct (pipe 70) is connected to the device 15, or both. The bracing member 32 generally serves to support the duct seal member 31, as described in more detail below. It is to be noted that in various embodiments, the present invention may comprise any embodiment of the adjusting connector member 30, 40 or the casing member 20 individually, as well as in combinations.

Referring to the device 15 illustrated in FIG.1 and the device 915 illustrated in FIG. 19 as an example, the ducts (pipes 70, 870 and bottle spout 875a) that are connected to the device 15, 915 may have a tubular shape and may be comprised in whole or in part of conduit, tubing (including medical or food grade tubing), pipeline, duct, hose, channel, vent or other similar objects or combinations of such objects that may be currently known in the relevant art or that may be developed in the relevant art in the future. The ducts (pipes 70, 870 and bottle spout 875a) may also have other shapes in other embodiments. For example, the ducts (pipes 70, 870 and bottle spout 875a) may have a cross-section that is approximately elliptical, triangular, square, rectangular, pentagonal, hexagonal, another polygonal shape, or another shape or combination of such shapes. The ducts (pipes 70, 870 and bottle spout 875a) may also be comprised of any materials suitable for constructing conduit, tubing, pipeline, duct, hose, channel, vent, containers, or similar objects. Examples include metals (such as steel, steel alloys, aluminum, copper, brass, or other metals or metal alloys), polymers (such as polyvinyl chloride (PVC), polyethylene, acrylonitrile butadiene styrene (ABS), rubber, synthetic rubber (including NEOPRENE), silicon, and other polymers), wood, glass, fiberglass, carbon-based and other composites, or other materials or a combination of such materials. Further, the ducts (pipes 70, 870 and bottle spout 875a) may have a variety of different thread types on the end thereof. For example, the ducts (pipes 70, 870 and bottle spout 875a) may have American Standard Pipe Taper Threads (NPT), American Standard Straight Coupling Pipe Threads (NPSC), American Standard Taper Railing Pipe Threads (NPTR), American Standard Straight Mechanical Pipe Threads (NPSM), American Standard Straight Locknut Pipe Threads (NPSL), American Standard Pipe Taper Threads (Dryseal; NPTF), American Fuel Internal Straight Pipe Thread (NPSF), British Standard Pipe Threads (tapered—BSPT, and parallel—BSPP), or any other type of threads. Alternatively, the duct (pipes 70, 870 and bottle spout 875a) may have no threads or a different type of connector means (such as a VICTAULIC® groove) on the end thereof. It is also to be noted that the device 15, 915 of the present invention may be used for ducts (pipes 70, 870 and bottle spout 875a) transporting gases or liquids or both, so that references to a “fluid” herein are intended to refer to both gases and liquids, as they may be carried by the ducts (pipes 70, 870 and bottle spout 875a) in each case. In still other embodiments, the ducts (pipes 70, 870 and bottle spout 875a) may comprise fittings or other connecting devices.

In the embodiment of the present invention illustrated in FIG. 1, the device 15 is generally comprised of a casing member 20, two adjusting connector members 30, 40, and casing connecting means, all of which are described in more detail below. In the illustrated embodiment, the casing member 20 is further comprised of a case body 21, a case cap 22, 23 positioned at each end of the case body 21, and case cap connecting means, which are described in more detail below. Case cap 23 may have any of the characteristics, features, structure, functions and operation as case cap 22, as described in more detail elsewhere herein. The case caps 22, 23 each have a connector opening 22a, 23a, respectively, positioned therein. The case caps 22, 23 may be removably or permanently connected to the case body 21 by the case cap connecting means, which are described in more detail below. Although the casing member 20 is comprised of portions that are approximately tubular-shaped and conically-shaped in the illustrated embodiment, the casing member 20 may have other shapes in other embodiments of the device 15, preferably so that the casing member 20 has an interior space 20a and a connector opening 22a (and other connector openings 23a in some embodiments) adjoining the interior space 20a, wherein the connector openings 22a, 23a are of a size and shape adapted to cooperate with the adjusting connector members 30, 40 in operation of the device 15, all as described in more detail below. As an example of an alternate shape, a portion of the exterior surface of the casing member 20 may be hexagonal in shape when viewed in cross-section from above an end of the casing member 20. As other examples, the casing member 20 may also have approximately elliptical, triangular, square, rectangular, pentagonal, another polygonal shape, other shapes having arcuate or linear portions, or another shape or combination of such shapes, as long as the casing member 20 cooperates with the adjusting connector members 30, 40 in operation of the device 15, all as described in more detail below.

Further, as illustrated in the device 15 of FIG. 1, the case body 21 may be comprised of two or more case body sections and case body section connecting means for removably or permanently connecting the case body sections together, which means are described in more detail below. For example, in the illustrated embodiment, the case body 21 is comprised of two case body conduit sections 21′, 21″ and a case body connecting section 21i. The case body conduit section 21′ is comprised of an end component 21a and a case body channel component 21b. The case body end component 21a is comprised of an open end 21c and threads 21d that are adjacent to the open end 2c. Preferably, the case body end component 21a is comprised of a suitable rigid or semi-rigid material so that it is rigid enough to support the adjusting connector member 30 in operation of the device 15 while the adjusting connector member 30 is connected to the device 15. For example, the case body end component 21a may be comprised of metal (such as steel, steel alloys, aluminum, copper, brass, or other metals or metal alloys), polymers (such as PVC, polyethylene, polypropylene, ABS, and other polymers), wood, fiberglass, carbon-based or other composites, or other materials or a combination of such materials. The case body channel component 21b is preferably comprised of a flexible or semi-flexible material, so that the case body channel component 21b may bend, but is rigid enough so that it doesn't collapse or become unduly constricted while being bent or in other operation of the device 15. Examples include rubber, synthetic rubber (including NEOPRENE), elastomers or other elastic polymers (such as silicone), or combinations of such materials, along with a combination that may including cloth, fabric, metal mesh, or other flexible or semi-flexible materials. In other embodiments, the case body channel component 21b may be comprised of a rigid or semi-rigid material, such as that comprising the case body end component 21a. Referring to the device 15 illustrated in FIG. 1 as an example, in each case, the preferred material is dependent upon a number of different factors, such as the anticipated size, shape and type of the ducts (pipe 70), the type of connection to be made to the ducts (pipe 70), the size, shape, material composition and configuration of the adjusting connector members 30, 40, the anticipated operating or installation temperatures of the device 15, the type of fluid carried by the ducts (pipe 70), the desired wall thickness and weight of the case body 21, the preferences of the user of the device 15, and other factors. The case body conduit section 21′ may be fabricated using any suitable means. For example, a case body end component 21a constructed of PVC may be formed by injection molding and a case body end component 21a constructed of a metal alloy may be formed by metal injection molding. As another example, a case body channel component 21b constructed of rubber or silicone may be cast in a mold. The case body end component 21a and the case body channel component 21b may be connected together by any appropriate means, such as a threaded connection, clasps, clamps, clips, pins, hinges, adhesives, adhesive tapes, epoxies, welding, fusing, nails, screws, nuts, bolts, or other types of fasteners or connectors, either alone or in conjunction with one another in different combinations. Alternatively, the case body end component 21a and the case body channel component 21b may be fabricated together as a single piece. It is to be noted that the case body end component 21a and the case body channel component 21b may each have a different shape in other embodiments. For example, the case body end component 21a and the case body channel component 21b may each have different cross-sectional shapes or may be longer or shorter than as illustrated in FIG. 1. In the case of a device 15 designed for room temperature domestic use and capable of accommodating ducts (pipe 70) in the range of ¾″ to ½″ nominal diameter, the case body end component 21a is preferably constructed of PVC and has the illustrated shape with a major inside diameter of approximately 1½ inches reducing down to a minor inside diameter of approximately ½″. In such cases, the case body channel component 21b is preferably constructed of rubber, with a more rigid portion (such as harder rubber or PVC) adjacent to the case body connecting section 21i, and has the illustrated shape with a uniform inside diameter of approximately ½″. The case body conduit section 21″ is comprised of an end component 21e and a case body channel component 21f. The case body end component 21e is comprised of an open end 21g and threads 21h that are adjacent to the open end 21g. Preferably, the case body end component 21e and the case body channel component 21f are comprised of the same type of materials as, and have features substantially the same as, the case body end component 21a and the case body channel component 21b, respectively.

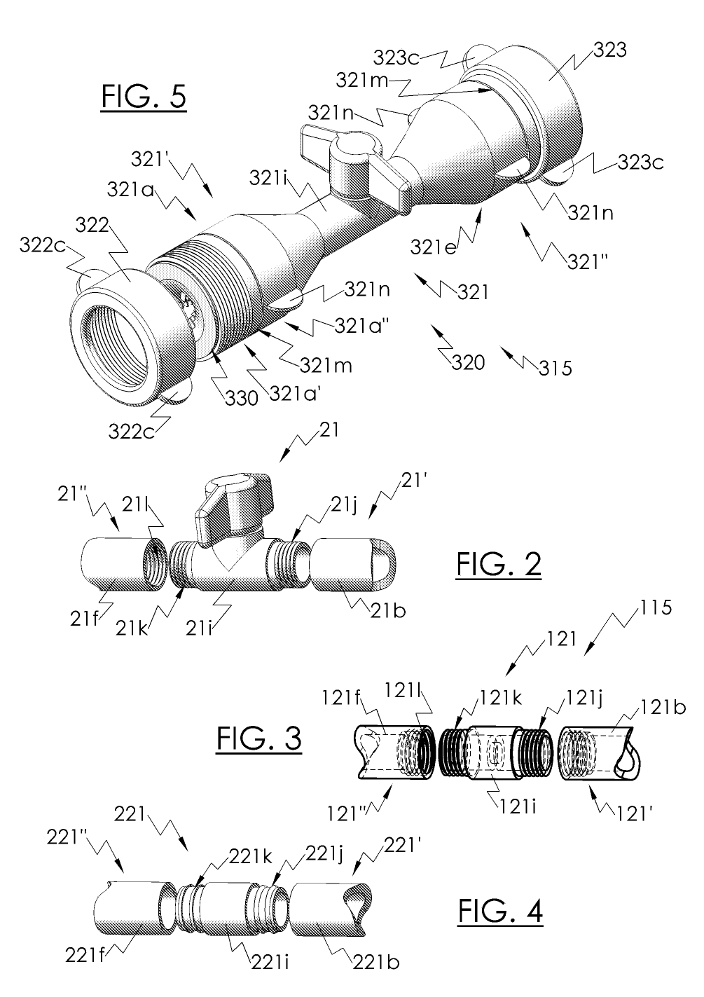

In the illustrated embodiment, the case body connecting section 21i is positioned between the two case body conduit sections 21′, 21″ and serves to connect the two case body conduit sections 21′, 21″ together in embodiments comprising such sections 21′, 21″. In various embodiments, the case body connecting section 21i may also perform other functions in operation of the device 15. For example, as illustrated in FIG. 1 and FIG. 2, the case body connecting section 21i is further comprised of a valve mechanism. The valve mechanism may be used to regulate the flow, or to completely stop the flow, of fluids through the device 15 when and as desired. This feature may greatly enhance operation of the device 15, as described in more detail below and illustrated in connection with FIG. 19. In such cases, the case body connecting section 21i may comprise any type of valve or flow regulating mechanism currently known in the relevant art or that may be developed in the relevant art in the future. For example, the case body connecting section 21i may comprise a check-valve, gate valve, ball valve, pressure regulator, backflow prevention device, needle valve, or a combination of such devices. In other embodiments, as illustrated in FIG. 3, the case body connecting section 121i may be comprised of an orifice mechanism. This type of mechanism may slow the flow of fluid through the device 115, but not in a manner that is typically adjustable by the user of the device 115. In yet other embodiments, as illustrated in FIG. 4, the case body connecting section 221i may be comprised of a tubular section that merely acts to connect the two case body conduit sections 221′, 221″ together. In other embodiments, and referring to FIG. 1 as an example, the case body connecting section 21i may take the form of almost any suitable type of fitting or connecting device. For example, the case body connecting section 21i may be in the form of a tee, a “Y” connector, or a 90 degree elbow. Case body connecting sections 21i shaped as an elbow may also have bends of 45 degrees, 22½ degrees, or another bend angle. Where the case body connecting section 21i is in the form of a tee or a “Y” connector, the case body connecting section 21i may be used to join a third case body conduit section (not illustrated) to the device 15, so that the contents of a third duct (not illustrated) may also be transferred through the device 15. Further, almost any suitable mechanism may be incorporated as a part of the case body connecting section 21i. For example, the case body connecting section 21i may incorporate flow meters, temperature sensors, pressure sensors, material composition sensors, alarms, and other devices, monitors and mechanisms. Further still, the case body connecting section 21i may have a different shape in other embodiments. For example, the case body connecting section 21i may have a different cross-sectional shape or may be longer or shorter than as illustrated in FIG. 1.

Continuing to refer to the device 15 illustrated in FIG. 1 as an example, the case body connecting section 21i may be comprised of almost any suitable material or combination of materials depending upon the nature of the features incorporated as a part of the case body connecting section 21i. In embodiments where mechanisms are incorporated, the case body connecting section 21i may be comprised of a suitable rigid or semi-rigid material to support the incorporated mechanism in operation of the device 15. For example, the case body connecting section 21i may be comprised of metal (such as steel, steel alloys, aluminum, copper, brass, or other metals or metal alloys), polymers (such as PVC, polyethylene, polypropylene, ABS, and other polymers), wood, fiberglass, carbon-based or other composites, or other materials or a combination of such materials. In other embodiments, it may be preferred that the case body connecting section 21i be comprised of a flexible or semi-flexible material, so that the case body connecting section 21i may bend, but is rigid enough so that it doesn't collapse or become unduly constricted while being bent or in other operation of the device 15. In such embodiments, the case body connecting section 21i may be comprised of rubber, synthetic rubber (including NEOPRENE), elastomers or other elastic polymers (such as silicone), or combinations of such materials, along with a combination that may including cloth, fabric, metal mesh, or other flexible or semi-flexible materials. In each case, the preferred material is dependent upon a number of different factors, such as the anticipated size, shape and type of the duct (pipe 70), the type of connection to be made to the duct (pipe 70), the size, shape, material composition and configuration of any incorporated mechanism, the anticipated operating or installation temperatures of the device 15, the type of fluid carried by the duct (pipe 70), the desired wall thickness and weight of the case body 21, the preferences of the user of the device 15, and other factors. The case body connecting section 21i may be fabricated using any suitable means. For example, and referring to FIG. 3, a case body connecting section 121i constructed of PVC may be formed by injection molding and a case body connecting section 121i constructed of a metal alloy may be formed by metal injection molding. Referring again to FIG. 1, in the case of a device 15 designed for room temperature domestic use and capable of accommodating ducts (pipe 70) in the range of 1″ to ½″ nominal diameter, the case body connecting section 21i is preferably constructed primarily of PVC and has a ball valve mechanism incorporated as a part thereof with a passage diameter of approximately ½″.

In embodiments of the device 15 comprising case body conduit sections 21′, 21″ and a case body connecting section 21i, case body section connecting means are used to permanently or removably connect the case body conduit sections 21′, 21″ to the case body connecting section 21i. For example, as illustrated in FIG. 2, the case body section connecting means are comprised of threads 21j, 21k on the case body connecting section 21i and corresponding threads (21l for 21″, but not illustrated for 21′) on case body conduit sections 21′, 21″. Thus, the case body conduit sections 21′, 21″ and the case body connecting section 21i may be removeably connected together by screwing the case body conduit sections 21′, 21″ onto, and by unscrewing them from, the case body connecting section 21i. Similarly, as illustrated in FIG. 3, the case body section connecting means are comprised of threads 121j, 121k on the case body connecting section 121i and corresponding threads (121l for 121″, but not illustrated for 121′) on case body conduit sections 121′, 121″. In embodiments where the threads 121j, 121k on the case body connecting section 121i are the same as the threads 21j, 21k on the case body connecting section 21i (as illustrated in FIG. 2), which is the preferred embodiment, the user of the appliances 15, 115 may use the case body connecting sections 21i, 121i interchangeably with each of the devices 15, 115. Thus, the device 15, 115 preferably incorporates a modularized system of interchangeable case body connecting sections 21i that may be used with the devices 15, 115 comprising the present invention. The modular system provides the user of the device 15, 115 with flexibility in that the user has the ability to use different case body connecting sections 21i, 121i incorporating different types of mechanisms, shapes and sizes when operating the device 15, 115 in different circumstances. In other embodiments, the case body section connecting means may take another form or forms. For example, as illustrated in FIG. 4, the case body section connecting means may take the forms of hose bard connectors 221j, 221k positioned on the ends of the case body connecting section 221i, which are adapted to fit adjacent to the interior surfaces of the case body channel components 221b, 221f, respectively. Referring again to FIG. 1 as an example, in yet other embodiments, case body section connecting means for connecting the case body connecting section 21i to the case body conduit sections 21′, 21″ may be comprised of any appropriate means, such as clasps, clamps, clips, pins, hinges, adhesives, epoxies, welding, fusing, nails, screws, nuts, bolts, or other types of fasteners or connectors, either alone or in conjunction with one another in different combinations. In addition, the case body section connecting means may also comprise a sealing compound (such as pipe dope) or another sealing mechanism, such as TEFLON tape, or a combination thereof. Preferably, the case section connecting means are comprised of a modularized system of threads 21j, 21k on the case body connecting section 21i and corresponding threads (21l for 21″, but not illustrated for 21′) on the case body conduit sections 21′, 21″.

Continuing to refer to the device 15 illustrated in FIG. 1 as an example, it is to be noted that the device 15 may be comprised of more than one case body connecting section 21i. For example, if the case body channel component 21b and the case body channel component 121b (illustrated in FIG. 3) are opposite ends of the same component, then the case body connecting section 21i and the case body connecting section 121i would be connected together in series between the case body conduit sections 21″, 121″. In this case, the interconnecting segment 21b, 121b would also be considered to be a case body conduit section, except that instead of having one end adapted to be connected to the adjusting connector member 30, both ends would be adapted to be connected to the adjoining case body connecting sections 21i, 121i. Conceivably, any number of such case body connecting sections 21i, 121i could be connected together in this manner. In addition, in embodiments where the case body connecting section 21i takes the form of a tee or a “Y” connector (not illustrated), one or more of the case body conduit sections 21′, 21″ may also be connected to a case body connecting section 21i, so that, for example, each case body conduit section 21′, 21″ would have a valve mechanism to regulate the flow of fluid through such case body conduit sections 21′, 21″. Thus, there are many potential combinations of case body connecting sections 21i, 121i that may be connected together with case body conduit sections 21″, 121″. All of such combinations are within the spirit and scope of the present invention as defined by the appended claims.

Another embodiment of a casing member 320 is illustrated in the device 315 of FIG. 5, in which the case body 321 is comprised primarily of rigid or semi-rigid materials. Thus, the case body conduit sections 321′, 321″ (which comprise case body end components 321a, 321e, respectively, but not case body channel components) may be comprised of a rigid or semi-rigid material, such as that comprising the case body end components 21a, 21e, as described in more detail above and illustrated in connection with FIG. 1. In addition, case body section connecting means may be used to removably or permanently connect the case body conduit sections 321′, 321″ to the case body connecting section 321i, which further comprises a valve mechanism in this embodiment. In other embodiments, the case body connecting section 321i may comprise substantially the same structure, features, characteristics, functions and operation as the case body connecting section 21i described in more detail above and illustrated in connection with FIG. 1. Preferably, the case body section connecting means are operatively the same as the case body section connecting means described above and illustrated in connection with FIG. 1 so that both devices 15, 315 are part of a modular system combining different embodiments of case body conduit sections 21′, 21″, 321′, 321″ and case body connecting sections 21i, 321i that may be operatively connected together interchangeably. In other embodiments, the case body conduit sections 321′, 321″ and the case body connecting section 321i may be constructed as a single component. In the device 315 illustrated in FIG. 5, the case body 321 is further comprised of a swivel connector 321m positioned on each case body end component 321a, 321e. Considering the case body end component 321a receiving the adjusting connector member 330 as an example, the swivel connector 321m is comprised of a sealing mechanism (not illustrated) that allows the portion 321a′ of the case body end component 321a adjacent to the adjusting connector member 330 to rotate relative to the remaining portions 321a″ of the case body end component 321. Thus, in using the device 315, the duct (not illustrated) and all portions of the casing member 320 except the portion 321a′ adjacent to the adjusting connector member 330 may be held stationary, while the portion 321a′ adjacent to the adjusting connector member 330 is rotated in order to connect the device 315 to the duct. To assist in this type of operation, the device 315 may be further comprised of case body tab portions 321n, 322c, 323c that may be used to rotate the various components comprising the device 315 relative to one another. In other embodiments, the case body tab portions 321n, 322c, 323c may not be present or may take another form, shape or configuration. Swivel connectors 321m of the type utilized in the device 315 are well known in the relevant art. In other embodiments, the swivel connector 321m may comprise any other type of swivel connector 321m currently known in the relevant art or that may be developed in the relevant art in the future. For example, rather than allowing the adjoining portions 321a′, 321a″ to rotate only circumferentially, the swivel connector 321m may allow the adjoining portions 321a′, 321a″ to move in almost any direction relative to one another.

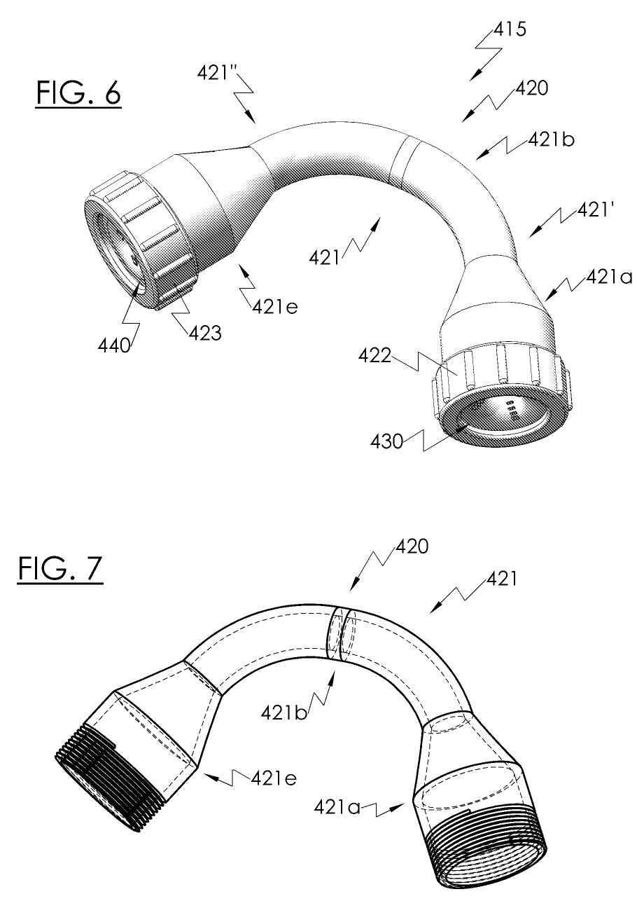

Yet another embodiment of a casing member 420 is illustrated in FIG. 6 and FIG. 7. FIG. 7 illustrates the case body 421 of the device 415 illustrated in FIG. 6, showing hidden lines of the case body 421 in phantom. In this embodiment, the casing member 420 does not have a case body connecting section similar to that 21i illustrated in FIG. 1. Instead, the casing member 420 is comprised of two case body end sections 421a, 421e that are connected together by a case body conduit section 421b. Preferably, the case body conduit section 421b is comprised of any flexible material that may comprise the case body channel components 21b, 21f described in more detail above and illustrated in connection with FIG. 1. In this embodiment, the casing member 420 may be bent into a U-shape during its operation. Thus, it is possible to connect the adjusting connector member 430 of the device 415 to a first container spout (not illustrated) while the first container is resting on a surface (such as a table or counter top). The spout of a second container (also not illustrated) may then be connected to the other adjusting connector member 440 while the second container is also resting on the same surface without the need to move the first container.

In the embodiment of the device 15 illustrated in FIG. 1, the case caps 22, 23 are approximately cylindrical in shape and may be permanently or removably attached to the open ends 21c, 21g of the case body 21 adjacent to the case caps 22, 23 by the case cap connecting means, which are described in more detail below. Considering the case cap 22 as an example, the case cap connecting means are comprised of threads 21d on the outside surface of the portion of the case body 21 adjacent to the open end 21c of the case body 21 and corresponding threads 22b on the interior surface of the tubular portion of the case cap 22. Thus, the case cap 22 may be placed over the open end 21c of the case body 21, and may then be screwed down onto the case body 21. In this embodiment, when the case cap 22 is screwed down onto the case body 21, a portion of the adjusting connector member 30 is compressed between the case cap 22 and the case body 21, holding the adjusting connector member 30 in place relative to the casing member 20 and forming a fluid-tight seal between the adjusting connector member 30 and the case body 21, all as described in more detail below. In other embodiments, the threads 21d, 22b may be oriented in a different configuration. For example, the threads 21d on the case body 21 may be positioned on the interior surface of the case body 21, and the corresponding threads 22b of the case cap 22 may be positioned on the exterior surface of a disc-shaped case cap 22. In this embodiment, the case cap 22 is screwed into the case body 21, holding the adjusting connector member 30 in place relative to the casing member 20 and forming a fluid-tight seal between the adjusting connector member 30 and the case body 21 in a manner similar to that described above.

In other embodiments, the case cap 22 may have a different shape, as long as the case cap 22 cooperates with the case body 21 and the adjusting connector member 30 to accommodate the operation of the device 15, as described in more detail herein. For example, the case cap 22 may facilitate a fluid-tight seal between the case body 21 and the adjusting connector member 30 in this embodiment, as described in more detail below. In addition, the connector opening 22a may be of almost any size and shape, as long as it cooperates with the casing connecting means (described in more detail below) in connecting the adjusting connector member 30 to the case body 21 and permitting the adjusting connector member 30 to be connected to the duct (pipe 70), which means that the duct (pipe 70) may be inserted into the casing member 20 and the adjusting connector member 30 in this embodiment. The connector opening 22a is generally of a size and shape adapted to have the duct (pipe 70) positioned within the connector opening 22a. The case cap 22 may generally be comprised of any materials or combinations of materials that may be used to construct the case body 21, as described in more detail above and illustrated in connection with FIG. 1. Although the case cap 22 need not be constructed of the same material as the case body 21, the case cap 22 is preferably constructed of the same material comprising the case body end component 21a, as described in more detail above. The case cap 22 may be fabricated using any suitable manufacturing means. For example, a case cap 22 comprised of PVC may be formed by injection molding and a case cap 22 comprised of a metal or metal alloy may be formed by metal injection molding. In some embodiments, as illustrated in FIG. 6, the case caps 422, 423 may have protruding ridges on the exterior surface thereof that assist the user in gripping the case cap 422, 423, particularly when the case cap 422, 423 is being screwed onto or off of the case body 421 or when the duct is being connected to the device 415.

In addition, and referring again to the embodiment of the present invention illustrated in FIG. 1, the case cap connecting means may be comprised of means other than the illustrated threads 21d, 22b, as long as they cooperate with the casing connecting means (described in more detail below) in connecting the adjusting connector member 30 to the case body 21 and are adapted to cooperate with the adjusting connector member 30 in operation of the device 15, all as described in more detail below. In the illustrated embodiment, such operation means, among other things, that the case cap connecting means permit the connector opening 22a to be of a size and shape adapted to receive the duct (pipe 70). For example, other case cap connecting means that may be used to removably connect the case cap 22 to the case body 21 comprise clasps, clamps, clips, pins, hinges, other pivoting connectors or other types of connectors, either alone or in conjunction with one another in different combinations. Examples of case cap connecting means that may be used to permanently connect the case cap 22 to the case body 21 include adhesives, epoxies, welding, fusing, nails, screws, nuts, bolts, or other fasteners or a combination of such means. Where the adjusting connector member 30 may be positioned within the interior space 20a of the casing member 20 other than through the open end 21c of the case body 21, the case cap 22 may also be fabricated as a part of the case body 21. It is to be noted, however, that the case cap connecting means may or may not be utilized to facilitate a fluid-tight seal between the adjusting connector member 30 and the case body 21. In some embodiments, a fluid-tight seal may be inherent in the type of case cap connecting means used (such as welding or fusing), or it may be created in whole or in part by the casing connecting means (as described in more detail below) or additional sealing means, such as o-rings, gaskets, flanges, washers, or other similar types of means or combinations of such means, as described in more detail below. The preferred characteristics of the case cap 22 and case cap connecting means are dependent upon a number of different factors, such as the anticipated range of shapes and sizes of the duct (pipe 70), the size, shape, material composition and configuration of the adjusting connector member 30, the type of casing connecting means (which are described in more detail below), the anticipated operating pressures of the device 15, the materials comprising and the shape of the case body 21, the preferences of the user of the device 15, and other factors. More preferred, the case cap 22 is generally of the shape illustrated in FIG. 1 and has the illustrated threaded case cap connecting means. It is to be noted that the case cap 23 may have substantially the same structure, features, characteristics, functions and operation as the case cap 22 described above and illustrated in connection with FIG. 1. The case cap 23 may be permanently or removably connected to the case body 21 at the case body open end 21g using case cap connecting means (threads 21h, 23b) and may cooperate with the adjusting connector member 40 in substantially the same manner as described above for case cap 22 and its associated adjusting connector member 30.

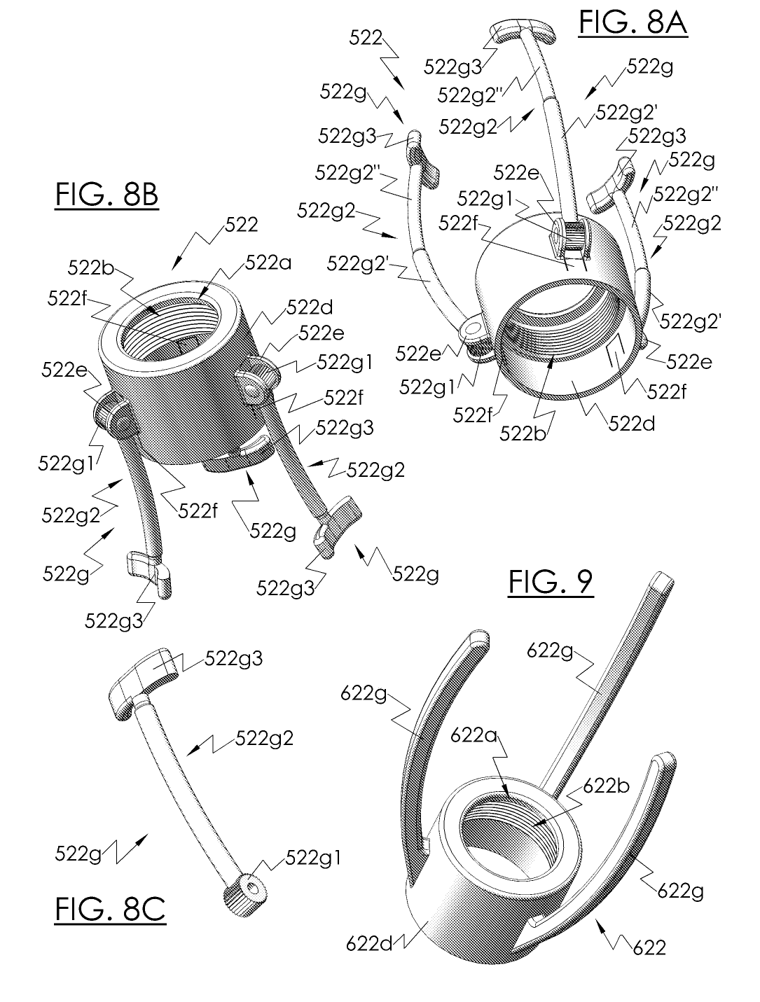

In some embodiments, as illustrated in FIG. 8A through FIG. 8B, the case cap 522 is further comprised of duct holding means adapted for holding the duct (not illustrated) in place relative to the device (not illustrated). In this embodiment, the case cap 522 may generally have substantially the same structure, features, characteristics, functions, and operation as the case caps 22, 23 described in more detail above and illustrated in connection with FIG. 1, except that the case cap 522 may have a greater length in the longitudinal direction of the case body (not illustrated) in order to accommodate the duct holding means. The case cap 522 is connected to the case body using case cap connecting means, which comprise the threads 522b in this embodiment. In this embodiment, the duct holding means are comprised of a plurality of duct support members 522e, 522f, 522g extending away from the casing member (case cap 522 in this embodiment), which are further comprised of holder brackets 522e, release tabs 522f, and holder supports 522g. Each holder support 522g is further comprised of a bracket connector 522g1, a support arm 522g2, and a support brace 522g3. The holder brackets 522e are positioned on the outside surface of the case cap body 522d. Each bracket connector 522g1 is positioned within a holder bracket 522e and is held in place there by a pin, dowel, bolt or other pivoting fastener so that the bracket connector 522g1 is free to pivot within the holder bracket 522e. Each bracket connector 522g1 also has a series of ratchet-type teeth around its outside surface. Each release tab 522f is an approximately U-shaped tab that is generally cut into the surface of the case cap body 522d. On the end of each release tab 522f, there is a protruding ridge (not illustrated) that is adapted to engage the teeth on the exterior surface of the bracket connector 522g1. The protruding ridge works in conjunction with the bracket connector 522g1 in a ratchet-type manner, as described in more detail below. The bracket connector 522g1 is connected to the support arm 522g2. In this embodiment, the support arm 522g2 is further comprised of two telescoping support arm members 522g2′, 522g2″. Thus, the support arm member 522g2″ may be retracted into the support arm member 522g2′ as desired to store the duct holding means when not in use or to adapt such means to hold ducts (or objects) of varying size and shape. A support brace 522g3 is attached to each support arm 522g2 at the distal end of the support arm 522g2. The support braces 522g3 and the support arms 522g2 are together adapted to engage the duct (or an object of which the duct is a part, such as a bottle or another container) in a manner so that the duct is held in place by the support brace 522g3 and the support arm 522g2. One or more of the support braces 522g3 or the support arms 522g2 or both may have a layer of a material having a relatively high level of tackiness on the surfaces facing the duct in order to assist the holder supports 522g3 in holding the duct in place. Support braces 522g3 need not be present or may have a different shape, size or configuration in different embodiments of the duct holding means.

In operation of the embodiment of the case cap 522 illustrated in FIG. 8A through FIG. 8B, the holder supports 522g may be retracted against the case cap body 522d when not in use, as illustrated in FIG. 8B. When the user of the device desires to use the duct support members (522d through 522g3 in this embodiment), the user may lift the holder support 522g away from the case cap body 522d. As this happens, the teeth on the bracket connector 522g1 slide past the protruding ridge portion of the release tab 522f as the bracket connector 522g1 rotates within the support bracket 522e. The user may also extend the support arm 522g2 by pulling on the support arm member 522g2″ so that it telescopes out from the support arm member 522g2′ the desired distance to engage the duct. The holder support 522g is moved until it is in the desire position relative to the duct, at which point the teeth of the bracket connector 522g1 engage the protruding ridge on the release tab 522f, so that the holder support 522g cannot move back in the direction of the outside surface of the case cap body 522d. Considering a bottle with a spout that comprises the duct as an example (not illustrated), the three holder supports 522g are fully or partially extended, as illustrated in FIG. 8A, so that they are positioned against the outside surface of the bottle in a manner that operatively holds the bottle tightly against the surfaces of the support braces 522g3 or the support arms 522g2 or both. When the user no longer needs the duct support members (522d through 522g3 in this embodiment), he or she may press down on the tab releases 522f (from the outside surface of the case cap body 522d), which causes the protruding ridge of the release tabs 522f to disengage from the teeth on the bracket connectors 522g1. This allows the bracket connectors 522g1 to rotate within the support brackets 522e (as long as the release tabs 522f are being depressed) in a manner that permits the holder supports 522g to be retracted back against the outside surface of the case cap body 522d.

It is to be noted that there are many potential variations on the duct holding means. For example, and referring to FIG. 8A through FIG. 8C as an example, there may be more or fewer holder supports 522g in other embodiments. In addition, some or all of the support arms 522g2 may not have a telescoping feature. Further, the holder supports 522g may have a different size, shape or configuration in other embodiments. For example, the support arms 522g2 may have a greater or lesser angle of curvature or a longer or shorter length (or both) depending upon the size of ducts (or other objects) that are anticipated for use with the duct holding means. In fact, various embodiments of the duct holding means may be comprised of various members having almost any combination of size, shape, and configuration depending upon the nature of the anticipated use of the duct holding means. Further still, the means of connecting the holder supports 522g to the case cap body 522d may be different than in the illustrated embodiment. For example, the connecting means may comprise a support bracket 522e, but the bracket connector 522g1 may be held in place in the support bracket 522e by a bolt with a wing nut that compresses the sides of the support bracket 522e against the bracket connector 522g1. Almost any type of suitable fastening means currently known in the relevant art or that may be developed in the relevant art in the future may be used to make this connection, such as clamps, clips, nuts, bolts, screws, dowels, pins, or other fastening means or a combination of such means. In the embodiment of the case cap 522 illustrated in FIG. 8A through FIG. 8C, the support bracket 522e and the release tab 522f are preferably constructed of the same material as the case cap body 522d (and the same as material as the case caps 22, 23, as described in more detail above and illustrated in connection with FIG. 1), but this need not be so in every embodiment. The holder supports 522g are also preferably constructed entirely of the same material, but this need not be so in every embodiment. The holder supports 522g may be constructed of any suitable rigid or semi-rigid material. Examples include metal (such as steel, steel alloys, aluminum, copper, brass, or other metals or metal alloys), polymers (such as PVC, polyethylene, polypropylene, ABS, and other polymers), wood, fiberglass, carbon-based or other composites, or other materials or a combination of such materials. In the illustrated embodiment, the holder supports 522g are preferably comprised entirely of a rigid polymer material, such as PVC or ABS. The case cap 522 may be constructed using any suitable means, such as injection molding for a case cap body (including support brackets 522e and release tabs 522f) and holder supports 522g constructed of PVC. Where any of such components are assembled from subcomponents, suitable connecting means may be used in the assembly process, such as adhesive, glue, epoxy, welding, fusing, clamps, clips, or other fastening means or a combination of such means.

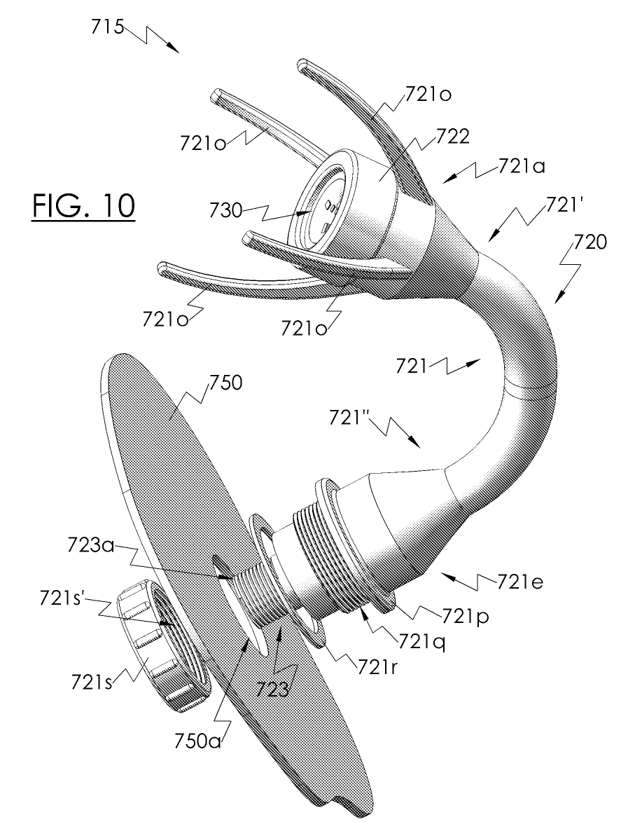

In other embodiments, the duct holding means may take an entirely different form, as illustrated in the case cap 622 of FIG. 9. In this embodiment, the case cap 622 may generally have substantially the same structure, features, characteristics, functions, and operation as the case caps 22, 23 described in more detail above and illustrated in connection with FIG. 1, except that the case cap 622 may have a greater length in the longitudinal direction of the case body (not illustrated) in order to accommodate the duct holding means. The case cap 622 is also adapted to be connected to a case body (not illustrated) using case cap connecting means (threads 622b), as described above and illustrated in connection with FIG. 1. In this embodiment, the duct holding means are comprised of a plurality of duct support members 622g extending away from the casing member (case cap 622 in this embodiment), which are further comprised of holder supports 622g that are rigidly connected to the case cap body 622d. The holder supports 622g are comprised of a material or materials that allows them to flex, but only with a considerable amount of force being exerted against them to do so. Thus, in this embodiment, the user of the case cap 622 may exert pressure against the holder supports 622g in order to bend them until they rest against the duct (or other object). Once the pressure is released from the holder supports 622g, they tend to retain that position until a relatively substantial force is applied to move them. Generally, this force is cumulatively greater than the force that is anticipated to be necessary to operatively hold the duct in place relative to the case cap 622 by the holder supports 622g. In various embodiments, the holder supports 622g may have almost any combination of sizes, shapes, and configurations depending upon the nature of their anticipated use. In this embodiment, the holder supports 622g may be constructed of any materials that permit the holder supports 622g to operate as intended. For example, the holder supports 622g may be constructed entirely of a semi-rigid polymer or metal or metal alloy. As another example, the holder supports 622g may be comprised of a length of metal or metal alloy cable that is encased within a semi-rigid polymer. Examples of other materials include metal (such as steel, steel alloys, aluminum, copper, brass, or other metals or metal alloys), polymers (such as PVC, polyethylene, polypropylene, ABS, and other polymers), wood, fiberglass, carbon-based or other composites, or other semi-rigid materials or a combination of such materials. In the illustrated embodiment, the holder supports 622g are preferably comprised entirely of a semi-rigid polymer material. The case cap 622 may be constructed using any suitable means used to construct the case caps 22, 23, as described in more detail above and illustrated in connection with FIG. 1. Holder supports 622g constructed of a semi-rigid polymer may be constructed by injection molding. Where the case cap body 622d and the holder supports 622g are fabricated separately, they may be assembled using any suitable connecting means, such as adhesive, glue, epoxy, welding, fusing, clamps, clips, or other fastening means or a combination of such means. Referring to the device 715 illustrated in FIG. 10, although the duct holding means may be incorporated as a part of the case body 721, rather than the case cap 722, the duct sealing means are preferably incorporated as a part of the case cap 522, 622, as described in more detail above and illustrated in connection with FIG. 8A through FIG. 9, because this provides the user of the device with the choice as to whether to have the duct sealing means present or not in operation of the device.

Yet another embodiment of a casing member 720 is illustrated in the device 715 of FIG. 10. This embodiment illustrates that the duct holding means (duct holder supports 721o in this embodiment) may also be incorporated as a part of the case body 721, rather than the case cap 722. In various embodiments, the duct holding means (duct holder supports 721o) incorporated as a part of the case body 721 may comprise any of the duct holding means described above and illustrated in connection with FIG. 8A through FIG. 9, as long as the duct holding means (duct holder supports 721o) do not unduly interfere with the operation of the device 715. Although the illustrated positioning of the duct holding means (duct holder supports 721o) on the case body end component 721a is the preferred positioning, the duct holding means (duct holder supports 721o) may be positioned on other portions of the case body 721 in other embodiments. The embodiment of the device 715 of FIG. 10 also illustrates that the casing member 720 need not be comprised solely of openings adapted for receiving adjusting connector members (such as adjusting connector member 730). In such embodiments, the casing member 720 may be further comprised of an object open end 723a and object connecting means (MIP adapter 723 in this embodiment) that are used to connect an object (not illustrated) to the casing member 720 at the object open end 723a. The object may generally comprise any of the structures, features, characteristics, functions and operation of the ducts (pipes 70, 870 and bottle spout 875a) described in more detail herein and illustrated in connection with FIG. 19. In addition, the object may be comprised in whole or in part of equipment, machinery, containers, tanks, or other objects or a combination of such objects to which it may be desirable to connect one or more ducts in a manner that provides for fluid communication between the interior space of the object with the interior space of the duct, as described in more detail below. In the embodiment of the device 715 illustrated in FIG. 10, the object connecting means are comprised of a male iron pipe (MIP) adapter 723 fabricated as a part of, and positioned at one end of, a case body 721. Also, in this embodiment, the MIP adapter 723 is positioned on the case body 721 so that the longitudinal axis of the MIP adapter 723 is collinear with the longitudinal axis of the case body 721. In other embodiments, the MIP adapter 723 (or other object connecting means) may be positioned on a different portion of the case body 721 or have a different orientation relative to the case body 721, as long as the position does not adversely affect the operation of the device 715, as described in more detail herein. For example, the MIP adapter 723 may extend from the sidewall of the case body 721 (as opposed to from the end of the case body 721) and may be oriented at a 45 degree angle relative to the longitudinal axis of the case body 721. In the illustrated embodiment, the MIP adapter 723 may be fabricated as a part of the case body 721, which is the preferred means of fabrication, or it may be fabricated separately from the case body 721 and attached to the case body 721 by any suitable means, such as adhesives, epoxies, welding, fusing, nails, screws, clips, clamps, nuts, bolts, or other fasteners or a combination of such means.

Referring to the embodiment of the device 715 illustrated in FIG. 10 as an example, the object connecting means (MIP adapter 723) may be comprised of almost any suitable means, and preferably means that may be used for making a fluid-tight connection. For example, the object connecting means may be comprised of a female iron pipe (FIP) adapter. As other examples, the object connecting means may be comprised of welding, fusing, adhesives, glues, epoxies, a garden hose connector, a connector having any type of the threads (male or female), luer lock fittings, SWAGELOK® fittings, quick connect/disconnect fittings, hose barbs, stepped tubing connectors, bushings, flanges, compression fittings, tubing and hose connectors, SPEEDFIT® connectors, couplings for connection using clamps or adhesives, or other means or a combination of such means. In addition, the object connecting means may be comprised in whole or in part of a segment of conduit, tubing (including medical or food grade tubing), pipeline, duct, hose, channel, vent, a spout or other outlet or inlet member, or other similar objects or a combination of such objects extending from a portion of the casing member 720. The preferred object connecting means for use with any particular embodiment of the device 715 depends upon a number of factors, such as the anticipated size, shape and type of materials comprising the object, the anticipated operating pressures of the device 715, the anticipated operating or installation temperatures of the device 715, the materials comprising and the shape and size of the casing member 720, the preferences of the user of the device 715, and other factors. More preferably, for an MIP adapter 723 comprised of PVC that is used to connect a pipe (not illustrated), the MIP adapter 723 is positioned and oriented as illustrated in FIG. 10 and is fabricated as a part of the case body 721 by injection molding.

Continuing to refer to FIG. 10, the object connecting means may also be used to connect the casing member 720 to the side wall of another pipe. Further, the object connecting means may also be comprised in whole or in part of another adjustable connecting means (which are described in more detail below) of the present invention. Further still, the object connecting means may be comprised in whole or in part of the object, such as a tank, container, machine or item of equipment or any portion of the same. For example, the object connecting means may be comprised of the case body 721 being a part of or affixed to the side wall of a tank (not illustrated), so that the device 715 connects a duct (not illustrated) to the interior space of the tank (which would comprise the object in this embodiment). As another example, the case body 721 may be a part of or affixed to a panel on a piece of machinery or equipment (panel 750 in the illustrated embodiment), so that the device 715 connects the duct to the portion of the machinery that utilizes fluid supplied by the duct. An embodiment of this type of connection is illustrated in FIG. 10, in which another object connecting means of the device 715 is comprised of a collar member 721p that extends around the circumference of the case base 721 at the case body end component 721e. In this embodiment, the equipment panel or the boundary wall of a container 750 has an opening 750a therein. The case body 721 is inserted into the opening 750a in the panel or boundary wall 750 until it abuts up against the collar member 721p. In this embodiment, the panel or boundary wall 750 and a washer 721r are held in place against the collar member 721p by a lock nut 721s. The lock nut 721s has threads 721s′ that correspond to threads 721q on the case body 721 adjacent to the collar member 721p, so that the lock nut 721s is screwed down onto the case body 721 threads 721q until the panel or boundary wall 750 and the washer 721r are held tightly between the collar member 721p and the lock nut 721s. In other embodiments, the panel or boundary wall 750 may be held in place against the collar member 721p by any suitable means, such as clasps, clamps, clips, pins, dowels, adhesives, epoxies, welding, fusing, nails, screws, nuts, bolts, flanges or other means or a combination thereof. Alternatively, the case body 721 and the panel or boundary wall 750 may be fabricated together as a single component. The washer 721r, which assists in forming a fluid-tight seal between the panel wall 750 and the case body 721, need not be present in all embodiments of the present invention.

Generally, and referring to the device 15 illustrated in FIG. 1 and in FIG. 11A through FIG. 12C as an example, the at least one adjusting connector member (adjusting connector member 30) is capable of connecting to ducts (pipe 70) that have a different range of sizes and shapes (relatively larger ducts) than the range of sizes and shapes of ducts (not illustrated, but relatively smaller ducts) that may be connected to the at least one additional adjusting connector member (adjusting connector member 40). Considering adjusting connector member 30 as an example for purposes of the present description, the adjusting connector member 30 (as adjustable connecting means in this embodiment) of the device 15 is positioned approximately within the open end 21c of the case body 21. By positioning “approximately within the case body open end 21c,” it is meant that the adjusting connector member 30 is generally intended to be positioned adjacent to and within the space bounded by the portion of the case body 21 adjacent to the case body open end 21c, but that in some embodiments the adjusting connector member 30 may be positioned slightly above or below or within such case body adjacent portion or that there may be other members, such as a washer (not illustrated), also placed in the case body open end 21c so that the adjusting connector member 30 may be slightly displaced from the case body open end 2c. As described in more detail below and illustrated in connection with FIG. 19, the end of the duct (pipe 70) is inserted into the device 15, so that the duct (pipe 70) extends into the adjusting connector member 30 as well. As is also illustrated in FIG. 11A through FIG. 11C, the at least one adjusting connector member (adjusting connector member 30) is further comprised of duct sealing means (duct seal member 31 in this embodiment), seal bracing means (bracing member 32 in this embodiment), thread engaging means (thread engaging member 33 in this embodiment), adjusting member internal connecting means for operatively connecting the sealing means (duct seal member 31), the seal bracing means (bracing member 32), or the thread engaging means (thread engaging member 33) or all of them together in various embodiments, and casing connecting means for connecting the at least one adjusting connector member (adjusting connector member 30) to the casing member 20, all of which are described in more detail below.

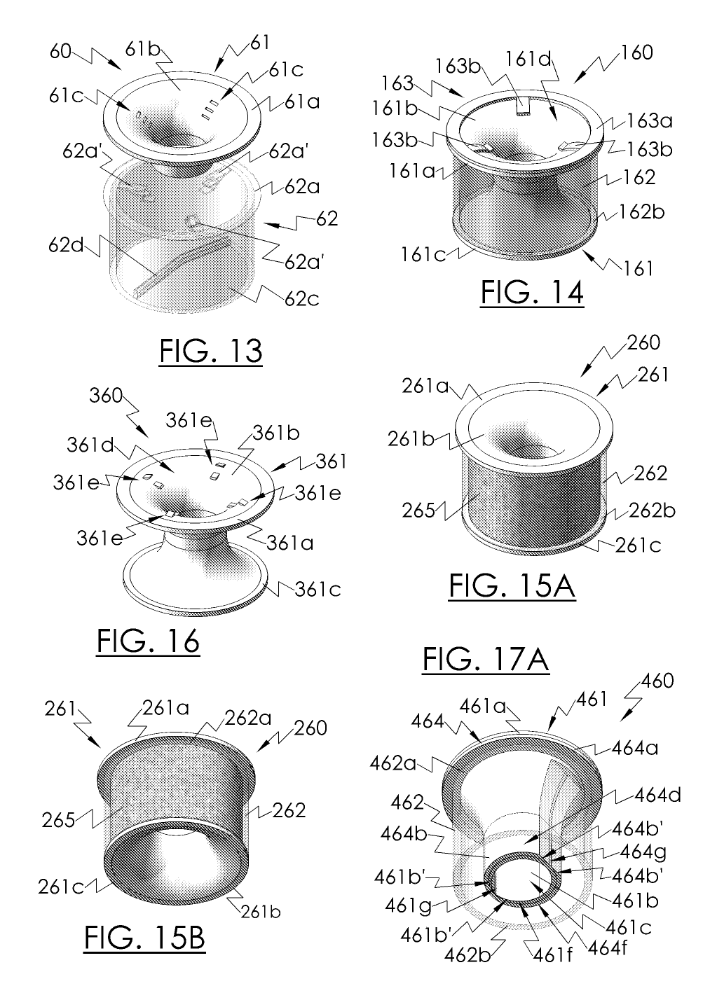

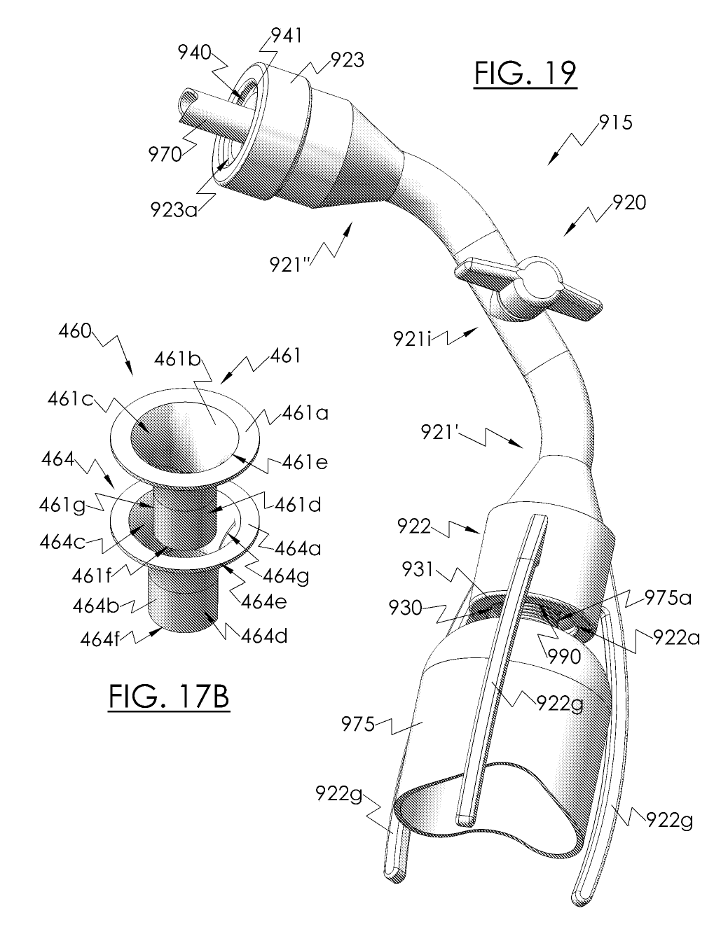

In the embodiment of the adjusting connector member 30 illustrated in FIG. 11A through FIG. 11C, the duct sealing means are adapted to conform to the shape of and adhere to the exterior surface of the duct (pipe 70) while the duct (pipe 70) is inserted into the adjusting connector member 30 (and the device 15 of FIG. 1), preferably forming a fluid tight seal between the duct (pipe 70) and the adjusting connecting means (adjusting connector member 30 in this embodiment). In the illustrated embodiment, the duct sealing means are generally comprised of a duct seal member 31, which is further comprised of an inlet seal flange portion 31a, a seal sheath portion 31b that extends from the seal flange portion 31a, and an outlet seal flange portion 31c that is positioned at the distal end of the seal sheath portion 31b. The duct seal member 31 is further comprised of a seal interior surface 31d and a seal exterior surface 32e. The seal sheath portion 31b also has a plurality of holes 31f positioned therein, which cooperate with the thread engaging member 33, as described in more detail below. In the illustrated embodiment, the duct seal member 31 is generally shaped as an hourglass, which also means that at least a portion of the duct seal member 31 is approximately shaped as a hyperboloid. In other embodiments, the duct sealing means (duct seal member 31 in the illustrated embodiment) may have a different shape, size or configuration. For example, as illustrated in FIG. 13, the duct seal member 61 may have an approximately hyperboloid shape, as described in more detail below. As another example, the duct seal member 461, 464 illustrated in FIG. 17A and FIG. 17B may have an approximately hyperboloid shape and may be comprised of two components 461, 464, as described in more detail below and illustrated in connection with FIG. 17A and FIG. 17B. In various embodiments, the duct seal member 31 may have any size, shape or configuration suitable to fulfill an intended function of being positioned adjacent to the exterior surface of the duct (pipe 70) while the duct (pipe 70) is operatively connected to the device 15.

The duct sealing means (duct seal member 31) are generally constructed in whole or in part of materials that permit them to change shape (typically expanding) to conform to the exterior surface of the largest size of duct (pipe 70) that may be connected to the duct seal member 31, while still maintaining the structural integrity of the duct seal member 31 during operation of the device 15. In addition, the materials are preferably compatible with the type of fluid anticipated to be carried by the duct (pipe 70). For example, the duct seal member 31 may be comprised of any suitable elastic material, such as rubber, synthetic rubber (including NEOPRENE), elastomers or other elastic polymers, or combinations of such materials, along with a combination that may including cloth, fabric or other flexible or semi-flexible materials. It is to be noted, however, that the duct seal member 31 need not be constructed entirely of flexible or elastic materials. For example, all or a portion of the inlet seal flange portion 31a, or another portion of the duct seal member 31, or any combination thereof, may be comprised of a rigid or semi-rigid material, such as wood, ceramic, metal, fiberglass, carbon-based or other composites, rigid or semi-rigid polymers (such as polyvinyl chloride and polycarbonate), or other rigid or semi-rigid materials or a combination of such materials. This may assist in facilitating a fluid-tight seal between the inlet seal flange portion 31a, the thread engaging member 33, the bracing member 32, the case body 21 or a combination thereof in some embodiments. The duct seal member 31 may be constructed using any suitable means. For example, a duct seal member 31 constructed entirely of synthetic rubber may be cast in a mold. As another example, a duct seal member 31 comprised of one or more materials may have various components assembled utilizing adhesives, welding, fusing or any other suitable means. Preferably, for devices 15 utilizing the duct seal member 31 of the illustrated embodiment and designed for use with tubular ducts (pipe 70) having a nominal diameter in the range of ½″ to ¾″ carrying potable water for domestic use, the duct seal member 31 has the configuration illustrated in FIG. 11A through FIG. 11C and is constructed entirely of NEOPRENE having a thickness in the range of 1/16 inch to ⅛ inch. It is also to be noted that in various embodiments of the present invention, the duct sealing means may have any structure, characteristics, features, functions, and operation disclosed for the sealing member and its ancillary members in U.S. patent application Ser. No. 11/879,346 filed on Jul. 17, 2007, Ser. No. 12/012,954 filed on Feb. 6, 2008, and U.S. Provisional Patent Application No. 61/062,428 filed on Jan. 25, 2008, and No. 61/066,258, entitled MODULAR COUPLING SYSTEM filed on Feb. 19, 2008. The full disclosure of each of these patent applications is incorporated herein by this reference.

As is best illustrated in FIG. 11A through FIG. 11C, the bracing means are adapted to (among other things) allow a portion of the duct seal member 31 (as duct sealing means) to change shape to conform to the shape of the exterior surface of the duct (pipe 70) at the end thereof, while the bracing means may also provide structural support to assist in holding the duct (pipe 70), the duct sealing means (duct seal member 31), and the thread engaging means (thread engaging member 33) operatively in place relative to one another and, in some embodiments, the casing member 20, all as described in more detail below. In the illustrated embodiment, the bracing means are comprised of a bracing member 32 having a brace inlet open end 32a and a brace outlet open end 32b. Also in the illustrated embodiment, the bracing member 32 is a tubular-shaped shell that is connected to the thread engaging member 33 and the duct seal member 31 by the adjusting member internal connecting means, which are described in more detail below. At least a portion of the bracing member 32 may be positioned approximately adjacent to the duct seal member 31. By “approximately adjacent,” it is meant that the bracing member 32 is intended to be positioned directly or indirectly adjacent to the duct seal member 32, but that other members (such as washers, gaskets, or the thread engaging member 33 in the illustrated embodiment) may be positioned between them. The bracing member 32 may have a different size and shape in other embodiments of the present invention. For example, where the case base 21 has a hexagonal cross-section, it may be necessary or desirable for the bracing member 32 to be hexagonal to facilitate its connection to the case base 21. The bracing member 32 may also be of a different shape as necessary to permit its operable connection to the duct seal member 31 or the thread engaging member 33 or both. As another example, the bracing member 32 may have one or more channels, openings, or other protrusions that are a part thereof. As yet another example, as described in more detail below and illustrated in connection with FIG. 13, the bracing member 62 may be combined with the thread engaging means 62a′. Referring again to FIG. 11A through FIG. 11C, and as described in more detail below, the bracing member 32, the duct seal member 31, and the thread engaging member 33 preferably cooperate to form a fluid-tight seal between one another and the case body 21 (see FIG. 1). The bracing member 32 may be constructed of any suitable material, preferably so it is capable of performing its functions of allowing a portion of the duct seal member 31 (as duct sealing means) to change shape to conform to the shape of the exterior surface of the duct (pipe 70) at the end thereof, while also providing structural support to assist in holding the duct (pipe 70), the duct sealing means (duct seal member 31), or the thread engaging means (thread engaging member 33), or any combination thereof, in place relative to one another and the casing member 20, all as desired and as described in more detail below. Preferably, the bracing member 32 is comprised of a rigid or semi-rigid material, such as metal (e.g., spring steel, copper, brass, aluminum, another steel, or steel or metal alloy), wood, ceramic, fiberglass, carbon-based or other composites, rigid or semi-rigid polymers (such as PVC, NYLON or NYLON/glass combination, and polycarbonate), or other rigid or semi-rigid materials or a combination of such materials. In addition, it is preferred that the material comprising the bracing member 32 be compatible with the fluid carried by the duct (pipe 70). The bracing member 32 may be constructed using any suitable means. For example, a bracing member 32 constructed entirely of PVC may be formed by injection molding. The bracing member 32 is preferably fabricated of one material as a single component. Alternatively, the bracing member 32 may be constructed of more than one component or of different materials or a combination of materials, which may be connected to one another by a suitable joining means, such as an adhesive, adhesive tape, glue, epoxy, welding, fusing, brazing, or other joining means or a combination of such means.

In the embodiment of the device 15 illustrated in FIG. 1, and as best illustrated in FIG. 11A through FIG. 11C, the thread engaging means are generally comprised of a thread engaging member 33. In addition to performing other functions, the thread engaging means (thread engaging member 33 in this embodiment) allow a portion of the duct sealing means (duct seal member 31) to change shape to conform to the shape of the exterior surface at the end of the duct (pipe 70), while also engaging any threads 70a on the exterior surface of the duct (pipe 70), which also may assist in holding the duct (pipe 70), the duct sealing means (duct seal member 31), and the bracing means (bracing member 32) in place relative to one another and the casing member 20, all as described in more detail below. In the illustrated embodiment, the thread engaging member 33 is comprised of a thread engaging flange member 33a and at least one thread engaging tab member 33b that extend from the interior perimeter of the thread engaging flange member 33a into the vicinity of the exterior surface 31e of the duct seal member 31. By “into the vicinity of the exterior surface 31e of the duct seal member 31,” it is meant that the at least one thread engaging tab member 33b may be positioned adjacent to the exterior surface 31e of the duct seal member 31 or may be positioned so that all or a portion of the at least one thread engaging tab member 33b is not adjacent to the duct seal member 31, as long as at least one thread engaging tab member 33b is close enough to such exterior surface 31e so that a portion of the at least one thread engaging tab member 33b extends through the duct seal member 31 enough so that such extending portion is adapted to engage any threads on the duct (pipe 70), as described in more detail below. Portions of the thread engaging tab members 33b extend through openings 31f in the duct seal member 31. Thus, as the duct (pipe 70) is inserted into the device 15 (and the adjusting connector member 30), the threads 70a on the duct (pipe 70) engage the portions of the thread engaging tab members 33b that extend through the openings 31f of the duct seal member 31. After initially engaging the thread engaging tab members 33b, the duct (pipe 70) may be twisted or rotated as it continues to be inserted into the adjusting connector member 30. This twisting or rotating motion, accompanied by the thread engagement between the threads 70a and the thread engaging tab members 33b, may cause the duct (pipe 70) to be drawn down into the duct seal member 31. The thread engaging means may also tend to assist in operatively holding the duct (pipe 70) in place in the duct seal member 31 once the duct (pipe 70) insertion is complete. Preferably, there is an approximately fluid-tight seal formed between the portions of the thread engaging members 33b that extend through the openings 31f in the duct seal member 31 and such openings 31f. It is to be noted that the seal need not be completely fluid-tight in every embodiment, as described in more detail below. This approximately fluid-tight seal may be accomplished by a relatively tight fit between each of such portions 33b and its corresponding opening 31f, or it may be accomplished by means of an adhesive, adhesive tape, epoxy, welding, fusing, clamps, clips, or other fastening or joining means or a combination of such means.

The thread engaging member 33 may have a different size and shape in other embodiments of the present invention. For example, where the case base 21 has a hexagonal cross-section, it may be necessary or desirable for the thread engaging flange member 33a to be hexagonal as well to facilitate the connection of the adjusting connector member 30 to the casing member 20. As another example, the thread engaging tab members 33b may have a different shape than that illustrated, which shape may allow them to conform to a different shape of opening 31f in the duct seal member 31. In other embodiments, there may be more or fewer thread engaging tab members 31b (rather than the three illustrated) or the thread engaging tab members 31b may have more or fewer portions extending through the openings 31f in the duct seal member 31, or both. For example, as illustrated in FIG. 12A through FIG. 12B, each thread engaging tab member 43b has three portions extending through the openings 41f in the duct seal member 41, as compared to four portions for each thread engaging tab member 33b in the embodiment illustrated in FIG. 11A through FIG. 11C. The thread engaging member 33 may be comprised of any suitable rigid or semi-rigid material, such as metal (such as steel, steel alloys, aluminum, copper, brass, or other metals or metal alloys), polymers (such as PVC, polyethylene, polypropylene, ABS, NYLON and NYLON/glass combinations, and other polymers), wood, fiberglass, carbon-based or other composites, or other materials or a combination of such materials. Although the thread engaging flange member 33a and the thread engaging tab members 33b are preferably comprised of the same material, they may be comprised of different materials in various embodiments. The thread engaging member 33 may be fabricated using any suitable means, such as injection molding for a thread engaging member 33 comprised of polymers and metal injection molding for a thread engaging member 33 comprised of metal. Preferably, the thread engaging member 33 is fabricated as a single piece from one material. Alternatively, the thread engaging tab members 33b may be separately fabricated and attached to the thread engaging flange portion 33a using any suitable means, such as adhesive, adhesive tape, glue or epoxy, welding, fusing, clasps, clamps, or other suitable attachment means or a combination of such means. More preferably, the thread engaging member 33 has the geometry illustrated in FIG. 11A through FIG. 11C, and is comprised of a NYLON/glass combination, which may be fabricated using injection molding. It is to be noted that there may be more than one thread engaging member 33 utilized in some embodiments of the present invention.

Adjusting member internal connecting means are used to operatively connect the components (duct seal member 31, bracing member 32, and thread engaging member 33 in the device 15) comprising the adjusting connecting member 30 together. In the embodiment of the device 15 illustrated in FIG. 1 and FIG. 11A through FIG. 11C, the components (duct seal member 31, bracing member 32, and thread engaging member 33) comprising the adjusting connecting member 30 may initially be in an unassembled form. The user of the device 15 may position the thread engaging member 33 adjacent to the exterior surface 31e of the duct seal member 31, so that the thread engaging flange member 33a is also adjacent to the inlet seal flange portion 31a. A portion of each of the thread engaging members 33b also extends through the openings 31f in the duct seal member 31, so that at least a portion of the thread engaging means (thread engaging tab members 33b in this embodiment) is adapted to be positioned between the duct (pipe 70) and the duct seal member 31. Preferably, there is a relatively tight fit between the thread engaging tab members 33b and the openings 31f, so that there is a fluid-tight seal between them. The user may then position the duct seal member 31 and the thread engaging member 33 within the bracing member 32 by slightly deforming the outlet seal flange portion 31c and then inserting that end of the duct seal member 31 into the bracing member 32. The user may then slide the duct seal member 31 along the interior surface of the bracing member 32 until the thread engaging flange member 33a is adjacent to the inlet open end 32a of the bracing member 32, and the outlet seal flange portion 31c of the duct seal member 31 is adjacent to the outlet open end 32b of the bracing member 32. Preferably, the size and shape of the duct seal member 31, the thread engaging member 33, and the bracing member 32 is such that the inlet seal flange portion 31a of the duct seal member 31 and the thread engaging member 33a fit tightly against one another and the inlet open end 32a of the bracing member 32, so that an approximately fluid-tight seal is formed between them within the anticipated operating pressure of the device 15. In addition, the size and shape of the duct seal member 31, the thread engaging member 33, and the bracing member 32 is preferably such that the outlet seal flange portion 31c of the duct seal member 31 fits tightly against the outlet open end 32b of the bracing member 32, so that an approximately fluid-tight seal is formed between them within the anticipated operating pressure of the device 15. In these embodiments, the adjusting member internal connecting means are comprised of the force and friction that holds the components (duct seal member 31, bracing member 32, and thread engaging member 33) comprising the adjusting connecting member 30 in place relative to one another.

As illustrated in FIG. 1, the user may then connect the assembled adjusting connector member 30 to the casing member 20 using the casing connecting means, which are described in more detail below. The user may then insert the duct (pipe 70) into the device 15 illustrated in FIG. 1 and FIG. 11A through FIG. 11C. As the duct (pipe 70) is inserted, it impinges upon the interior surface 31d of the duct seal member 31. In addition, if the duct (pipe 70) has threads 70a on its exterior surface at the end thereof, the threads 70a may impinge (or engage) upon the portions of the thread engaging tab members 33b that extend through the openings 31f in the duct seal member 31. In order to maximize thread 70a/thread engaging tab member 33b engagement, the user may twist or rotate the duct (pipe 70) in a manner that causes the threads 70a to interlock with the thread engaging tab members 33b. It may not, however, be necessary to rotate the duct (pipe 70) in all embodiments of the present invention. As the duct (pipe 70) is rotated, the thread engaging tab members 33b may draw the duct (pipe 70) down into the duct seal member 31. As the duct (pipe 70) is drawn into the duct seal member 31, the duct seal member 31 changes shape (which may also typically involve expanding) to conform to the exterior surface of the duct (pipe 70). Preferably, the duct (pipe 70) is drawn into the duct seal member 31 a distance that is beyond the openings 31f so that a fluid-tight seal is formed between the duct seal member 31 and the duct (pipe 70) around the perimeter of the duct (pipe 70) exterior surface. In some embodiments, the portions of the thread engaging tab members 33b that extend through the openings 31f in the duct seal member 31 may retract into the openings 31f as the duct seal member 31 conforms to fit the duct (pipe 70) as the duct (pipe 70) is being inserted. In these embodiments, this retraction allows the interior surface 31d of the duct seal member 31 to be positioned adjacent to the exterior surface of the duct (pipe 70), while still preferably maintaining a fluid-tight seal between the openings 31f and the thread engagement tab members 33b. As fluid is transferred from the duct (pipe 70) through the device 15 in operation of the device 15, there are no leaks that allow fluid to escape from the device 15 or the interfaces between the duct (pipe 70) and the device 15. When the user is finished using the device 15, the adjusting connector member 30 may be removed from the casing member 20. The adjusting connector member 30 may then be disassembled for cleaning and reassembled for future reuse.

Although the embodiment of the adjusting connector member 30 described immediately above is the preferred embodiment, the adjusting member internal connecting means may take other forms in other embodiments. For example, rather than the compressive force and friction between the components (duct seal member 31, bracing member 32, and thread engaging member 33) holding them together relative to one another, one or more of the components may be connected to any combination of other components by removable means, such as friction, clasps, clamps, clips, pins, hinges, other connectors or other types of connectors, either alone or in conjunction with one another in different combinations. In addition, the adjusting member internal connecting means may connect one or more of the components (duct seal member 31, bracing member 32, and thread engaging member 33) together, or to any combination of other components by permanent means, such as adhesives, epoxies, welding, fusing, nails, screws, nuts, bolts, or other fasteners or a combination of such means. Alternatively, in some embodiments, the components (duct seal member 31, bracing member 32, and thread engaging member 33) may be fabricated as a single component, either alone or as a part of the casing member 20. It is to be noted, however, that the case cap connecting means may or may not be utilized to facilitate a fluid-tight seal between the adjusting connector member 30 and the case body 21. In some embodiments, a fluid-tight seal may be inherent in the type of adjusting member internal connecting means used (such as welding or fusing), or it may be created in whole or in part by the casing connecting means (as described in more detail below). The preferred characteristics of the adjusting member internal connecting means are dependent upon a number of different factors, such as the anticipated range of shapes and sizes of the duct (pipe 70), the size, shape, material composition and configuration of the adjusting connector member 30, the type of casing connecting means (which are described in more detail below), the anticipated operating pressures of the device 15, the materials comprising and the shape of the case body 21, the preferences of the user of the device 15, and other factors.

It is to be noted that the adjusting connector member 40 illustrated in FIG. 12A through FIG. 12C may have substantially the same structure, characteristics, features, functions and operation as any of the embodiments of the adjusting connecting member 30 illustrated in FIG. 11A through FIG. 11C, except that adjusting connector member 40 is adapted to receive ducts (such as pipe 70) that are generally smaller than for use with the adjusting connector member 30. In the illustrated embodiment, the shape and exterior dimensions of the adjusting connector member 40 are substantially the same as those for adjusting connector member 30, so that they are interchangeable in use with the casing member 20, as described in more detail below. Thus, in the illustrated embodiment, the adjusting connector member 40 is generally comprised of a duct seal member 41, a bracing member 42, a thread engaging member 43, and adjusting member internal connecting means for operatively connecting such components together, which means may comprise any of the embodiments of the adjusting member internal connecting means described above and illustrated in connection with FIG. 11A through FIG. 11C. The duct seal member 41 is further comprised of an inlet seal flange portion 41a, a seal sheath portion 41b that extends from the seal flange portion 41a, and an outlet seal flange portion 41c that is positioned at the distal end of the seal sheath portion 41b. The duct seal member 41 is further comprised of a seal interior surface 41d and a seal exterior surface 42e. The seal sheath portion 41b also has a plurality of openings 41f positioned therein, which cooperate with the thread engaging member 43 in the same manner as the thread engaging member 33 cooperates with the openings 31f of the duct seal member 31, as described above and illustrated in connection with FIG. 11A through FIG. 11C. In the illustrated embodiment, the duct seal member 41 is also generally shaped as an hourglass (so that at least a portion is also shaped approximately as a hyperboloid), and the bracing member 42 has a brace inlet open end 42a and a brace outlet open end 42b. Also in the illustrated embodiment, the bracing member 42 is a tubular-shaped shell member. In the illustrated embodiment, the thread engaging member 43 is comprised of a thread engaging flange member 43a and at least one thread engaging tab member 43b that extends from the interior perimeter of the thread engaging flange member 43a into the vicinity of the exterior surface 41e of the duct seal member 41. Portions of the thread engaging tab members 43b extend through openings 41f in the duct seal member 41. Thus, as the duct (such as pipe 70) is inserted into the device 15 (and the adjusting connector member 40), any threads on the duct engage the portions of the thread engaging tab members 43b that extend through the openings 41f of the duct seal member 41 in the same manner as for the thread engaging member 33, as described above and illustrated in connection with FIG. 11A through FIG. 11C

In other embodiments, the adjusting connector members 30, 40 may have different shapes, sizes, features and characteristics. For example, as illustrated in FIG. 13, the adjusting connector member 60 is comprised of a duct seal member 61 (as duct sealing means), a bracing member 62 (as bracing means), and adjusting member internal connecting means for connecting such components together, which means may comprise any of the adjusting member internal connecting means described above and illustrated in connection with FIG. 11A through FIG. 11C. In this embodiment, the duct seal member 61 is further comprised of an inlet seal flange portion 61a and a seal sheath portion 61b that extends from the seal flange portion 61a. The seal sheath portion 61b has a plurality of openings 61f positioned therein, which cooperate with the bracing member 62 in the manner described in more detail below. In this embodiment, the duct seal member 61 is generally shaped as a hyperboloid, but not as an hourglass, illustrating (among other things) how the duct sealing means may have a different shape and configuration in various embodiments of the present invention. Also in this embodiment, the bracing member 62 is semi-transparent and is comprised of a bracing flange member 62a, a bracing shell portion 62c that extends from the bracing flange portion 62a, at least one duct stop member 62d, and thread engaging means (thread engaging tab members 62a′ in this embodiment), which allow a portion of the duct sealing means (duct seal member 61) to change shape to conform to the shape of the exterior surface at the end of the duct (not illustrated), while also engaging any threads on the exterior surface of the duct, which also may assist in holding the duct, the duct sealing means (duct seal member 61), and the bracing means (bracing member 62) in place relative to one another and the casing member (not illustrated), all in a manner similar to that described for the thread engaging means described in more detail above and illustrated in connection with FIG. 11A through FIG. 11C. In the illustrated embodiment, the thread engaging means are comprised of at least one thread engaging tab member 62a′ that extends from the interior perimeter of the bracing flange member 62a into the vicinity of the exterior surface of the duct seal member 61. In other embodiments, the at least one thread engaging tab member 62a′ may extend from another portion of the bracing member 62 and the bracing member 62 may not have a bracing flange portion 62a. Portions of the thread engaging tab members 62a′ extend through openings 61c in the duct seal member 61, and the thread engaging tab members 62a′ operatively cooperate with the duct seal member 61 in substantially the same manner as the thread engaging tab members 33b cooperate with the duct seal member 31, as described in more detail above and illustrated in connection with FIG. 11A through FIG. 11C. Thus, as the duct is inserted into the adjusting connector member 60, any threads on the duct may engage the portions of the thread engaging tab members 62a′ that extend through the openings 61c of the duct seal member 61 in substantially the same manner as the thread engaging tab members 33b engage the threads 70a of the duct (pipe 70), as described in more detail above and illustrated in connection with FIG. 11A through FIG. 11C. The embodiment of the adjusting connector member 60 illustrated in FIG. 13 illustrates, among other things, how the bracing means and the thread engaging means may be combined into a common structural element (bracing member 62 in this embodiment). It is to be noted that there are other combination structures that may also be utilized, all of which are included within the spirit and scope of the invention as defined by the appended claims. The at least one duct stop member 62d is adapted to stop the travel of the duct into the adjusting connector member 60 at a predetermined position. The at least one duct stop member 62d may have a different size, shape or configuration in other embodiments. For example, the at least one duct stop member 62d may not extend across the entire width of the interior space of the bracing member 62. In addition, other embodiments of the bracing means (such as bracing members 32, 42, 162, 262, 362, 462 illustrated in FIG. 11A through FIG. 17A) may also incorporate one or more duct stop members (such as duct stop member 62d) as a part thereof. In other embodiments, the casing member (such as casing members 20, 320, 420, 720, 820, 820, 920, 1020 described in more detail above and illustrated in connection with FIG. 1 through FIG. 10 and FIG. 18 through FIG. 20) may also incorporate one or more duct stop members (such as duct stop member 62d) as a part thereof.

Yet another embodiment of an adjusting connector member 160 is illustrated in FIG. 14. In this embodiment, the adjusting connector member 160 is comprised of a duct seal member 161 (as duct sealing means), a bracing member 162 (as bracing means), a thread engaging member 163 (as thread engaging means), and adjusting member internal connecting means for operatively connecting such components together, which means may comprise any of the adjusting member internal connecting means described above and illustrated in connection with FIG. 11A through FIG. 11C. In this embodiment, the duct seal member 161 is further comprised of an inlet seal flange portion 161a, a seal sheath portion 161b that extends from the seal flange portion 161a, and an outlet seal flange portion 161c positioned at the distal end of the seal sheath portion 161b. This embodiment of the seal sheath portion 161b does not, however, have any openings (such as openings 61f illustrated in FIG. 13), illustrating how the duct seal member 161 need not have such openings in all embodiments of the present invention. Also in this embodiment, the bracing member 162 is a semi-transparent, tubular-shaped shell member having a brace inlet open end 162a and a brace outlet open end 162b. The duct seal member 161 and the bracing member 162 operatively cooperate in substantially the same manner as the duct seal member 61 and the bracing member 62, as described in more detail above and illustrated in connection with FIG. 11A through FIG. 11C, except that the thread engaging member 163 is not positioned between the inlet seal flange portion 161a and the brace inlet open end 162a. In this embodiment, the thread engaging member 163 is comprised of a thread engaging flange member 163a and thread engaging tab members 163b that extend from the interior perimeter of the thread engaging flange member 163a into the vicinity of the interior surface 161d of the duct seal member 161, so that at least a portion of the thread engaging means (thread engaging tab members 163b in this embodiment) is adapted to be positioned between the duct (not illustrated) and the duct seal member 161. The thread engaging flange member 163a is positioned approximately adjacent to the inlet seal flange portion 161a. By “approximately adjacent,” it is meant that the thread engaging flange member 163a is generally intended to be positioned adjacent to inlet seal flange portion 161a, but that in some embodiments the thread engaging flange member 163a may be positioned adjacent to another portion (such as the interior surface of the seal sheath portion 161b) of the duct seal member 161, or there may be other members placed between the thread engaging flange member 163a and the inlet seal flange portion 161a.

This embodiment illustrates how the thread engaging means (thread engaging member 163) may be positioned on the surface (interior surface 161d) of the duct seal member 161 opposite of the bracing means (bracing member 162). The thread engaging tab members 163b are adapted to engage any threads on a duct (not illustrated) that may be inserted into the adjusting connector member 160. Thus, if the duct has threads on its exterior surface at the end thereof, the threads may impinge (or engage) upon the thread engaging tab members 163b. The user may twist or rotate the duct in a manner that causes the threads to interlock with the thread engaging tab members 163b, so that the thread engaging tab members 163b draw the duct down into the duct seal member 161 as the duct is rotated. As the duct is drawn into the duct seal member 161, it changes shape (which may also typically involve expanding) to conform to the exterior surface of the duct, preferably forming a fluid-tight seal between the duct seal member 161 and the duct around the perimeter of the duct exterior surface. In cases involving relatively small duct sizes, the duct may impinge upon the interior surface 161d of the duct seal member 161 without engaging the thread engaging tab members 163b. In such cases, friction alone may be used to hold the duct in place relative to the duct seal member 161.

Yet another embodiment of an adjusting connector member 260 is illustrated in FIG. 15A and FIG. 15B. In this embodiment, the adjusting connector member 260 is comprised of a duct seal member 261 (as duct sealing means), a bracing member 262 (as bracing means), at least one compressible insert 265 (as a portion of the bracing means), and adjusting member internal connecting means for connecting such components together, which means may comprise any of the adjusting member internal connecting means described above and illustrated in connection with FIG. 11A through FIG. 11C. In this embodiment, the duct seal member 261 is further comprised of an inlet seal flange portion 261a, a seal sheath portion 261b that extends from the seal flange portion 261a, and an outlet seal flange portion 261c positioned at the distal end of the seal sheath portion 261b. This embodiment of the seal sheath portion 261b does not, however, have any openings (such as openings 61f illustrated in FIG. 13). Also in this embodiment, the bracing member 262 is a semi-transparent, tubular-shaped shell member having a brace inlet open end 262a and a brace outlet open end 262b. The duct seal member 261 and the bracing member 262 operatively cooperate in substantially the same manner as the duct seal member 61 and the bracing member 62, as described in more detail above and illustrated in connection with FIG. 11A through FIG. 11C, except that there is not a thread engaging member positioned between the inlet seal flange portion 261a and the bracing inlet open end 262a. In this embodiment, the bracing means are further comprised of one or more compressible inserts 265 positioned in the space between the duct seal member 261 and the bracing member 262. As the duct (not illustrated) is inserted into the adjusting connector member 260, the duct seal member 261 generally changes shape (typically expanding radially outward), exerting pressure against the compressible insert 265. As the compressible insert 265 is compressed, it creates a counter force that exerts pressure radially inward against the duct seal member 261, which is forced against the exterior surface of the duct, tending to hold the duct in place relative to the duct seal member 261. In various embodiments, the compressible insert 265 may have almost any shape or combination of shapes, as long as the shape of the compressible insert 265 allows it to perform an intended function of exerting radial inward pressure against the duct seal member 261. As is illustrated in FIG. 15A and FIG. 15B, one compressible insert 265 may extend circumferentially around the entire adjacent exterior surface (not illustrated because it is covered by the compressible insert 265) of the duct seal member 261. Alternatively, one or more compressible inserts 265 may be placed adjacent to only a portion of such exterior surface of the duct seal member 261. In the illustrated embodiment, the compressible insert 265 is used without thread engaging means (such as the thread engaging tab members 62a′, 163b illustrated in FIG. 13 and FIG. 14, respectively). In other embodiments, the adjusting connector member 260 may further comprise thread engaging means (such as the thread engaging member 163 illustrated in FIG. 14), so that such thread engaging means may operate in conjunction with a compressible insert 265.

In some embodiments, as illustrated in FIG. 15A and FIG. 15B, the at least one compressible insert 265 may be comprised of a resilient porous or open-cell foam material (such as polyurethane foam or another type of open cell foam material or a combination of such foam materials) that is compatible with the fluid to be carried by the duct (not illustrated). In addition, the compressible insert 265 may have voids, channels or other passages or a combination of the same positioned within the foam that collapse when the duct is inserted into the adjusting connector member 260. In some embodiments, the foam comprising the compressible insert 265 may be covered with a thin layer or covering of flexible material, such as rubber or another flexible polymer, to isolate the compressible insert 265 from the fluid carried by the duct. In other embodiments, the at least one compressible insert 265 may be comprised of one or more hollow, inflatable bladders that contain a compressible fluid, such as air or nitrogen. In this case, the bladders may be constructed in whole or in part of rubber, synthetic rubber, another flexible polymer, cloth, fabric, or other flexible materials or a combination of such materials. In yet other embodiments, the compressible inserts 265 may be comprised of semi-flexible materials that have a structure allowing them to be compressed, while exerting a counter force against compression. For example, the compressible inserts 265 may be comprised of a semi-flexible polymer, such as silicone, having a “honeycomb” pattern of voids or channels therein. It is to be noted that many different combinations of materials and structures may be utilized in conjunction with the at least one compressible insert 265, all of which are included within the spirit and scope the present invention as defined by the appended claims. The compressible insert 265 may be fabricated using any suitable means, which are well known in the relevant art. The various components comprising the adjusting connector member 260 may be assembled by deforming the outlet seal flange portion 261c of the duct seal member 261, inserting the deformed end of the duct seal member 261 into and through the interior open space of the compressible insert 265, and then also deforming the end of the compressible insert 265 adjacent to the outlet seal flange portion 261c and inserting the deformed end into and through the inlet open end 262a of the bracing member 262.

Yet another embodiment of a duct seal member 361 is illustrated in FIG. 16. In this embodiment, the duct seal member 361 is comprised of an inlet seal flange portion 361a, a seal sheath portion 361b that extends from the inlet seal flange portion 361a, and an outlet seal flange portion 361c positioned at the distal end of the seal sheath portion 361b. This embodiment of the seal sheath portion 361b does not, however, have any openings (such as openings 61f illustrated in FIG. 13). Instead, the duct seal member 361 further comprises thread engaging means (thread engaging tab members 361e in this embodiment), illustrating how the duct seal member 361 may incorporate such means in some embodiments of the present invention. In this embodiment, the thread engaging means are comprised of at least one thread engaging tab member 361e that extends from the interior surface of the duct seal member 361, so that at least a portion of the thread engaging means (at least one thread engaging tab member 361e in this embodiment) is positioned between the duct (not illustrated) and the duct seal member 361. In the illustrated embodiment, the thread engaging tab members 361e are adapted to engage any threads on a duct (not illustrated) that may be inserted into the duct seal member 361. Thus, if the duct has threads on its exterior surface at the end thereof, the threads may impinge (or initially engage) upon the thread engaging tab members 361e. The user may twist or rotate the duct in a manner that causes the threads to interlock with the thread engaging tab members 361e, so that the thread engaging tab members 361e draw the duct down into the duct seal member 361 as the duct is rotated. As the duct is drawn into the duct seal member 361, the duct seal member 361 changes shape (which may also typically involve expanding) to conform to the exterior surface of the duct, preferably forming a fluid-tight seal between the duct seal member 361 and the duct around the perimeter of the duct exterior surface. In cases involving relatively small duct sizes, the duct may not engage the thread engaging tab members 361e. In such cases, friction alone may be used to hold the duct in place relative to the duct seal member 361. The duct is preferably inserted into the duct seal member 361 a distance beyond the thread engaging tab members 361e, so that the thread engaging tab members 361e do not unduly interfere with the formation of a fluid-tight seal between the duct seal member 361 and the exterior surface of the duct. The thread engaging tab members 361e are preferably constructed from the same material as the duct seal member 361 and are fabricated as a single piece, such as by casting in a mold. Alternatively, the thread engaging tab members 361e may be constructed from a different material, such as a rigid or semi-rigid polymer, and may be connected to the interior surface 361d of the duct seal member 361 by any suitable connecting or fastening means, such an adhesive, adhesive tape, epoxy, welding, fusing, or other fastening or connecting means or a combination of such means. Further, there may be fewer or more thread engaging tab members 361e than as illustrated, and the thread engaging tab members 361e may have a different shape in other embodiments, as long as they are adapted to perform their intended function of engaging any threads present on the duct, as described in more detail above.

Another embodiment of adjustable connecting means (adjusting connector member 460 in this embodiment) is illustrated in FIG. 17A and FIG. 17B. Generally, this adjustable connecting means may comprise any of the aspects, features, characteristics, structures, functions and operations of any of the inventions disclosed in U.S. Nonprovisional patent application Ser. No. 11/879,346 filed on Jul. 17, 2007, Ser. No. 12/012,954 filed on Feb. 6, 2008, and U.S. Provisional Patent Application No. 61/062,428 filed on Jan. 25, 2008, which also name as inventor the inventor of the present invention. The entire disclosure of each of these patent applications is incorporated herein by this reference. In this embodiment, the adjustable connecting means are comprised of an adjusting connector member 460, which is further comprised of duct sealing means, bracing means, and adjusting member internal connecting means to connect such means operatively together, all of such means being described in more detail below. The duct sealing means are generally comprised of a hollow internal seal member 461, a hollow external seal member 464, and seal connecting means to operatively connect them together, as described in more detail below. In this embodiment, the internal seal member 461 is comprised of an internal seal flange portion 461a adjacent to an internal seal inlet 461e and an internal seal sheath portion 461b that extends from the internal seal flange portion 461a. The internal seal sheath portion 461b is further comprised of an internal seal interior surface 461c and an internal seal exterior surface 461d, which are bounded by the internal seal inlet 461e and an internal seal outlet 461f. The internal seal sheath portion 461b also has an internal seal slit 461g that runs from the interior seal outlet 461f along the internal seal sheath portion 461b a portion of the way toward the interior seal inlet 461e. The portions 461b′ of the internal seal sheath portion 461b adjacent to the internal seal slit 461g are generally tapered so that the thickness of the internal seal sheath portion 461b is gradually reduced to zero thickness at the internal seal slit 461g. In this embodiment of the adjusting connector member 460, the external seal member 464 is comprised of an external seal flange portion 464a adjacent to an internal seal inlet 464e and an external seal sheath portion 464b extending from the external seal flange portion 464a. The external seal sheath portion 464b is further comprised of an external seal interior surface 464c and an external seal exterior surface 464d, which are bounded by the external seal inlet 464e and an external seal outlet 464f. The external seal sheath portion 464b also has an external seal slit 464g that runs from the external seal outlet 464f along the external seal sheath portion 464b a portion of the way toward the external seal inlet 464e. The portions 464b′ of the external seal sheath portion 464b adjacent to the external seal slit 464g are generally tapered so that the thickness of the external seal sheath portion 464b is gradually reduced to zero thickness at the external seal slit 464g.

In this embodiment, the internal seal member 461 is positioned within the external seal member 464, so that the internal seal exterior surface 461d faces and may be adjacent to the external seal interior surface 464c. The internal seal flange portion 461a is also positioned adjacent to the external seal flange portion 464a and the two are operatively connected by the seal connecting means. Preferably, the seal connecting means connect the internal seal flange portion 461a and the external seal flange portion 464a, as portions of the internal seal member 461 adjacent to the internal seal inlet 461e and of the external seal member 464 adjacent to the external seal inlet 464e, respectively, in a manner that forms a fluid-tight seal between them. This fluid-tight seal (and the seal connecting means generally) may be formed by compression of the internal seal flange portion 461a against the external seal flange portion 464a or by use of other suitable means, such as adhesive, adhesive tape, glue, epoxy, welding, fusing, clasps, clamps, fasteners or other suitable attachment means or a combination of such means, in each case as applied to all or a portion of the internal seal flange portion 461a or the external seal flange portion 464a or both. In addition, the internal seal slit 461g is preferably positioned so that it is on approximately the opposite side of the duct sealing means from the external seal slit 464g. Further, the duct sealing means (internal seal member 461 and external seal member 464) are generally constructed in whole or in part of materials that permit them to expand to conform to the exterior surface of the largest size of duct (not illustrated, but which may be similar to pipe 70) that may be connected to the adjusting connector member 460, while still maintaining the structural integrity of the internal seal member 461 and the external seal member 464 during operation of the adjusting connector member 460. In addition, the materials are preferably compatible with the type of fluid anticipated in the interior space of the duct. For example, the internal seal member 461 and the external seal member 464 may each be comprised of any suitable elastic material, such as rubber, synthetic rubber (including NEOPRENE), elastomers or other elastic polymers, or combinations of such materials, along with a combination that may including cloth, fabric or other flexible or semi-flexible materials. It is to be noted, however, that the internal seal member 464 and the external seal member 464 need not be constructed entirely of flexible or elastic materials. For example, the internal seal flange portion 461a and the external seal flange portion 464a, or a portion of the internal seal sheath portion 461b and the external seal sheath portion 464b adjacent to the internal seal flange portion 461a and the external seal flange portion 464a, respectively, or any combination thereof, may be comprised of a rigid or semi-rigid material, such as wood, ceramic, metal, fiberglass, carbon-based or other composites, rigid or semi-rigid polymers (such as polyvinyl chloride and polycarbonate), or other rigid or semi-rigid materials or a combination of such materials. This may assist in facilitating a fluid-tight seal between the internal seal flange portion 461a, the external seal flange portion 464a, the bracing member 462, and the case body (not illustrated) in some embodiments.

Thus, as the duct is inserted into the internal seal member 461 and the external seal member 464, the internal sheath member 461b and the external sheath member 464b change shape to conform to the shape of the exterior surface of the duct at the end thereof so that they are adapted to fit tightly against the exterior surface of the duct. In order to accommodate a larger size of duct, the internal seal sheath portion 461b and the external seal sheath portion 464b may also expand radially in a manner that causes the internal seal exterior surface 461d to slide circumferentially along the external seal interior surface 464c. As this expansion occurs, the internal seal slit 461g and the external seal slit 464g may also increase in size. Because the internal seal slit 461g and the external seal slit 464g are on approximately opposite sides, the seal slits 461g, 464g do not overlap as they widen, so that portions of the internal seal sheath portion 461b and the external seal sheath portion 464b are positioned adjacent to the duct around the duct's entire circumference. This preferably forms a fluid-tight seal between the exterior surface of the duct and portions of the internal seal member 461 and the external seal member 464. It is to be noted that the duct sealing means of this embodiment (internal seal member 461 or external seal member 464 or both) may have a different configuration in other embodiments. For example, the internal seal member 461 may not have a slit. Similarly, the external seal member 464 may not have a slit. Alternatively, both the internal seal member 461 and the external seal member 464 may not have a slit. In other embodiments, either or both slits 461g, 464g may have a different shape. For example, either or both of the slits 461g, 464g may be longer or shorter or may have a curved shape. As yet another example, the portion of the internal seal sheath portion 461b or the external seal sheath portion 464b or both adjacent to the slits 461g, 464g, respectively, may not be tapered. As still another example, the placement of the slits 461g, 464g relative to one another may be different (i.e., they may not be placed on opposite sides). Further, there may be more than one slit 461g, 464g in either or both of the internal seal member 461 and the external seal member 464, respectively. Further still, although it is preferable that the internal seal sheath portion 461b and the external seal sheath portion 464b are not attached to one another so that they can move relative to one another, in some embodiments they may be attached at one or more portions thereof. In yet other embodiments, the internal seal sheath portion 461b and the external seal sheath portion 464b may not be positioned adjacent to one another over their entire facing surfaces 461d, 464c. In yet other embodiments, the internal seal member 461 and the external seal member 464 may be fabricated together as a single component. The internal seal member 461 and the external seal member 464 may be constructed using any suitable means. For example, internal seal members 461 and external seal members 464 constructed entirely of synthetic rubber may be cast in a mold. As another example, an internal seal member 461 and an external seal member 464 comprised of one or more materials may have various components assembled utilizing adhesives, welding, fusing or any other suitable means. Further, the seal connecting means are utilized in connecting the internal seal member 461 and the external seal member 464, as described in more detail above.

In the embodiment of the adjusting connector member 460 illustrated in FIG. 17A and FIG. 17B, the adjusting connector member 460 is further comprised of a bracing member 462 (as bracing means), and adjusting member internal connecting means for operatively connecting the duct sealing means (internal seal member 461 and external seal member 464) to the bracing member 462. In this embodiment, the adjusting member internal connecting means may be comprised of any embodiment of the adjusting member internal connecting means described above and illustrated in connection with FIG. 11A through FIG. 11C. Also in this embodiment, the bracing member 462 is a semi-transparent, tubular-shaped shell member having a brace inlet open end 462a and a brace outlet open end 462b. The bracing member 462 may generally have any of the structures, features, characteristics, functions and operation as any of the bracing members 32, 42, 62 described in more detail above and illustrated in connection with FIG. 11A through FIG. 13. The duct sealing means 461, 464 and the bracing member 462 operatively cooperate in substantially the same manner as the duct seal member 61 and the bracing member 62, as described in more detail above and illustrated in connection with FIG. 11A through FIG. 11C, except that thread engaging means are not positioned between the external seal flange portion 464a and the brace inlet open end 462a. In addition, the adjusting connector member 460 may also utilize at least one compressible insert (not illustrated), similar to the at least one compressible insert 265 described in more detail above and illustrated in connection with FIG. 15A and FIG. 15B. Preferably, for adjusting connector members 460 utilizing internal seal members 461 and external seal members 464 of the illustrated embodiment and designed for use with tubular ducts having a nominal diameter in the range of ½″ to ¾″ carrying potable water for domestic use, the internal seal member 461 and external seal member 464 have the configuration illustrated in FIG. 17A and FIG. 17B and are constructed entirely of NEOPRENE having a thickness in the range of 1/16 inch to ⅛ inch.

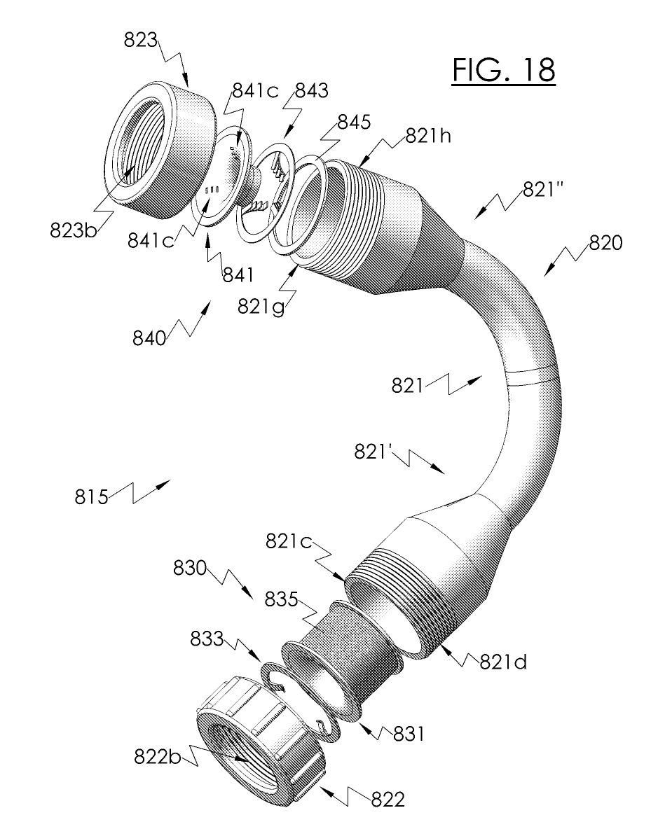

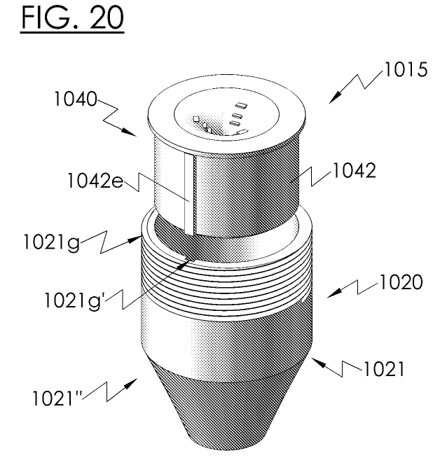

It is to be noted that in some embodiments, as illustrated in FIG. 18, the adjusting connector members 830, 840 may comprise various combinations of components. For example, adjusting connector member 830 is comprised of a duct seal member 831, a compressible insert 835, and a thread engaging member 833. Each of these components 831, 835, 833 may comprise any of the structures, features, characteristics, functions, and operation as the corresponding components 161, 261, 265, 263, respectively, described in more detail above and illustrated in connection with FIG. 14 through FIG. 15B. In this embodiment, however, the adjusting connector member 830 does not include any bracing means. Instead, the casing member 820 (and the case body 821 in particular) serves to perform the function of a bracing member. In other embodiments, the adjusting connector member 830 may comprise the duct seal member 831 alone. In still other embodiments, the adjusting connector member 830 may comprise the duct seal member 831 in combination with either the compressible insert 835 or the thread engaging member 833, but not both. As another example, the adjusting connector member 840 is comprised of a duct seal member 841, a thread engaging member 843, and a washer 845. The duct seal member 841 and the thread engaging member 843 may comprise any of the structures, features, characteristics, functions, and operation as the corresponding components 61, 33, respectively, described in more detail above and illustrated in connection with FIG. 11A through FIG. 11C and FIG. 13. The washer 845 may be used to assist in forming a fluid-tight seal between the thread engaging member 843 and the case body 821 in some embodiments. Once again, the adjusting connector member 840 does not include any bracing means. Instead, the casing member 820 (and the case body 821 in particular) serves to perform the function of a bracing member. In other embodiments, the adjusting connector member 840 may comprise the duct seal member 841 alone, but without any openings 84c. Alternatively, the adjusting connector member 840 may comprise the duct seal member 841 in combination with only the thread engaging member 843. The adjusting connector members 830, 840 are held in place within the open ends 821c, 821g of the case body 821 by the case cap connecting means, which comprise the threaded connections 821d, 822b, 821h, 823b in this embodiment. Although the embodiment of the device 15 illustrated in FIG. 1 and FIG. 11A through FIG. 12C is the preferred embodiment, it is to be noted that there are numerous potential variations in the structure, features, characteristics and operation of the present invention. In each of these various embodiments, the adjusting member internal connecting means, as described above and illustrated in more detail in connection with FIG. 1 through FIG. 17B, may be used to operatively connect one or more of the components comprising the adjusting connector member 830, 840.

Referring again to the embodiment of the device 15 illustrated in FIG. 1 and FIG. 11A through FIG. 12C, each of the adjusting connector members 30, 40 is positioned approximately within an open end 21c, 21g of the case body 21 and operatively connected to the casing member 20 by casing connecting means, which are described in more detail below. By “approximately within,” it is meant that at least one component comprising the adjusting connector members 30, 40, such as the thread engaging flange member 33a or the inlet seal flange portion 41a, respectively, are generally intended to be positioned adjacent to the case body open ends 21c, 21g, respectively, but that other items, such as washers, o-rings or other members, may be positioned between such at least one component and the case body open ends 21c, 21g, respectively, in some embodiments. For example, in the case of adjusting connector member 30, it may be desirable in some cases to position a washer (not illustrated, but similar to the washer 845 illustrated in FIG. 18) between the thread engaging flange member 33a and the case body open ends 2c. This may be desirable because the thread engaging flange member 33a and the case body 21 may both be comprised of rigid materials that require a more flexible material between them (such as the washer) in order to form a fluid-tight seal between them. In contrast, as is the case with adjusting connector member 40, the duct seal member 41 (which may be comprised of a flexible or elastic material) may alone provide for the formation of a fluid-tight seal between the other components of the adjusting connector member 30 (or the case cap 23 in some embodiments) and the case body 21. In the illustrated embodiment, as the case cap 22 is screwed down onto the case body 21, the case body open end 21c and the portion of the case cap 22 adjacent to the connector opening 22a are pressed against the inlet seal flange portion 31a of the duct seal member 31 and the thread engaging flange member 33a of the thread engaging member 33. This compression, acting as casing connecting means to operatively connect the adjusting connector member 30 to the casing member 20, may also provide a fluid-tight seal between the adjusting connector member 30 and the casing member 20. In addition, the inlet seal flange portion 41a of the duct seal member 41 is compressed between the case body open end 21g and the portion of the case cap 23 adjacent to the connector opening 23a as the case cap 23 is screwed down onto the case body 21, which may form a fluid-tight seal between the adjusting connector member 40 and the casing member 20. Thus, a fluid-tight chamber (not illustrated) may be formed, which is bounded by the interior surfaces 31d, 41d of the duct seal members 31, 41, respectively, the internal surfaces of the case body 21, and the internal surfaces of the ducts (pipe 70). In other embodiments, the casing connecting means may be comprised of any other suitable means for operatively, as well as permanently or removably, connecting the adjusting connector members 30, 40 to the casing member 20. For example, one or more components comprising the adjusting connector members 30, 40 may be connected to the case cap 22, 23, respectively, or the case body 21 or both by an adhesive, adhesive tape, glue or epoxy or a combination of the same. Other possible casing connecting means may include welding, fusing, clasps, clamps, hinges, pins, dowels, screws, nuts, bolts, or other suitable attachment or fastening means or a combination of such means.

Generally, and continuing to refer to the device 15 illustrated in FIG. 1 and FIG. 11A through FIG. 12C as an example, the casing connecting means may also comprise a modular aspect, which creates a modular system of interchangeable casing members 20 and adjusting connector members 30, 40. For example, both the adjusting connector members 30, 40 of the device 15 and the casing member 20 are comprised of casing connecting means adapted for operatively connecting the adjusting connector members 30, 40 to the casing member 20. In the illustrated embodiment, the casing connecting means of the adjusting connector member 30 are further comprised of the inlet seal flange portion 31a, the thread engaging flange member 33a, and the bracing member 32 that cooperate with the portion of the case body 21 adjacent to the case body open end 21c and the portion of the case cap 22 adjacent to the connector opening 22a to permit the adjusting connector member 30 to be connected to the casing member 20. In this embodiment, the casing connecting means may also comprise a washer (not illustrated, but similar to the washer 845 illustrated in FIG. 18) that assists in forming a fluid-tight seal between the adjusting connector member 30 and the casing member 20 so that fluids contained within the device 15 do not leak out through the seams formed between the adjusting connector member 30 and the casing member 20. Although a fluid-tight seal is preferably formed between the adjusting connector member 30 and the case body 21, a fluid-tight seal need not be formed in all embodiments. In the illustrated embodiment, the inlet seal flange portion 31a and the thread engaging flange member 33a are each generally shaped approximately as an annulus, while the bracing member 32 is approximately tubular in shape. The portion of the case cap 22 adjacent to the connector opening 22a is approximately annular in shape, while the portion of the case body 21 adjacent to the case body open end 21c is annularly shaped at its open end 21c, with a cylindrical portion bounding the case body interior space 20a that extends away from such end 2c. The shapes and sizes of these components (adjusting connector member 30, case body 21, and case cap 22) is such that the bracing member 32 fits within the cylindrical portion of the case body 21 adjacent to the casing interior space 20a, while the inlet seal flange portion 31a and the thread engaging flange member 33a (including any washer) of the adjusting connector member 30 is positioned adjacent to and compressed between the annular portion of the case body 21 adjacent to the case body open end 21c and the annular portion of the case cap 22 adjacent to the connector opening 22a. Thus, the adjusting connector member 30 is connected to the casing member 20 by the casing connecting means, which generally comprise the size and shape of the components (adjusting connector member 30, case body 21, and case cap 22) and the case cap connecting means operating in cooperation with one another.

The casing member 20 and the other adjusting connector member 40 of the embodiment of the device 15 illustrated in FIG. 1 and FIG. 11A through FIG. 12C incorporate the same casing connecting means described above with respect to adjusting connector member 30, so that adjusting connector member 40 is interchangeable with adjusting connector member 30 in operation of the device 15. For example, the portion of the case body 21 adjacent to the other open end 21g of the case body 21 and the case cap 23 have features and characteristics that are operatively the same as those for the portion of the case body 21 adjacent to the open end 21c of the case body 21 and the case cap 22, respectively, described above. In addition, the adjusting connector member 40 is also comprised of an inlet seal flange portion 41a, a thread engaging flange portion 43a, and a bracing member 42 that cooperate with the portion of the case body 21 adjacent to the case body open end 21g and the portion of the case cap 23 adjacent to the duct opening 23a to permit the adjusting connector member 40 to be connected to the casing member 20. Thus, the inlet seal flange portion 41a and the thread engaging flange portion 43a are shaped approximately as an annulus, while the bracing member 42 is approximately tubular-shaped, and all of them are generally of the same cross-sectional size and shape as the inlet seal flange portion 31a, the thread engaging flange portion 33a, and the bracing member 32, respectively. The portion of the case cap 23 adjacent to the connector opening 23a is approximately annular in shape, while the portion of the case body 21 adjacent to the case body open end 21g is annularly shaped at its open end 21g, with a cylindrical portion bounding the casing interior space 20a that extends away from such end 21g. The shapes and sizes of these components (adjusting connector member 40, case body 21, and case cap 23) is such that the inlet seal flange portion 41a and the thread engaging flange portion 43a fit within the cylindrical portion of the case body 21 adjacent to the casing interior space 20a, while the inlet seal flange portion 41a and the thread engaging flange portion 43a (including any washer) of the adjusting connector member 40 are positioned adjacent to and compressed between the annular portion of the case body 21 adjacent to the case body open end 21g and the annular portion of the case cap 23 adjacent to the duct opening 23a. As a result, the adjusting connector member 40 is connected to the casing member 20 by casing connecting means that are operatively equivalent to the casing connecting means used to connect adjusting connector member 30 to the casing member 20. Consequently, adjusting connector member 40 may be connected to the casing member 20 at the open end 21c of the case body 21, and adjusting connector member 30 may be connected to the casing member 20 at the other open end 21g of the case body 21, in each case using the casing connecting means described above and illustrated in connection with the device 15 illustrated in FIG. 1 and FIG. 11A through FIG. 12C.

It is to be noted that any of the embodiments of any of the adjusting connector members 60, 160, 260, 360, 460, 830, 840 described in more detail above and illustrated in connection with FIG. 13 through FIG. 18 may also comprise the same casing connecting means, so that any of such adjusting connector members 60, 160, 260, 360, 460, 830, 840 may be operatively connected to the casing member 20 at the open ends 21c, 21g of the case body 21 as part of a modular system of interchangeable adjusting connector members 30, 40, 60, 160, 260, 360, 460, 830, 840 and casing members 20, 320, 420, 720, 820, 920. It is also to be noted that the shape and configuration of each adjusting connector member 30, 40, 60, 160, 260, 360, 460, 830, 840 and each casing member 20, 320, 420, 720, 820, 920, in each case comprising the casing connecting means, need not be exactly the same in order to provide for a modular system. For example, as illustrated in FIG. 1 and FIG. 18, the adjusting connector members 30, 40 have one shape and configuration (which includes a bracing member 32, 42), while the adjusting connector members 830, 840 have a different shape and configuration (which do not include a bracing member, and have a different shape and configuration of thread engaging means 833, 843). Nevertheless, the adjusting connector members 830, 840 may be adapted to be interchangeable with the adjusting connector members 30, 40 as part of a modular system. It is also to be noted that there are many potential variations in the casing connecting means that may be utilized in the modular coupling system of the present invention. Generally, any suitable means currently known in the relevant art or developed in the relevant art in the future may be used, as long as such means are used consistently in a manner that accommodates the connection of all of the adjustable connecting means comprising the modular coupling system to all of the casing members comprising the modular coupling system. Thus, and referring to the device 15 illustrated in FIG. 1 as an example, the adjusting connector members 30, 40 and the casing member 20 may have interacting portions of almost any shape or size, as long as the shape and size of such interacting portions cooperate to ensure that the adjusting connector members 30, 40 of the system can be operatively connected to the casing member 20. For example, the adjusting connector members 30, 40 and the casing member 20 may have a hexagonal shape, as is disclosed in U.S. Provisional Patent Application No. 61/066,258, entitled MODULAR COUPLING SYSTEM filed on Feb. 19, 2008. Another example is presented in the device 1015 illustrated in FIG. 20, in which the adjusting connector member 1040 has a ridge portion 1042e positioned on the bracing member 1042. The ridge portion 1042e fits into and operatively cooperates with a slot 1021g′ positioned in the open end 1021g of the case body 1021 that comprises the casing member 1020. In this embodiment, if the adjusting member internal connecting means provide a permanent means of attachment, then the ridge portion 1042e and the slot 1021g′ tend to prevent the adjusting connector member 1040 from rotating within the case body open end 1021g if the duct (not illustrated) is rotated during its insertion into the device 1015.

A method of operating a device 915 of the present invention to connect to ducts (pipe 970 and bottle spout 975a) of various sizes and shapes is illustrated by reference to FIG. 19. One duct (pipe 970) is connected to an adjusting connector member 940, which is comprised of a duct seal member 941, a thread engaging member (not illustrated), and a bracing member (not illustrated), but which have substantially the same structure, features, characteristics, functions, and operation as the duct seal member 41, the thread engaging member 43, and the bracing member 42, respectively, described in more detail above and illustrated in connection with FIG. 1 and FIG. 12A through FIG. 12C. The other duct (bottle spout 975a) is inserted into an adjusting connector member 930, which is comprised of a duct seal member 931, a thread engaging member (not illustrated), and a bracing member (not illustrated), but which have substantially the same structure, features, characteristics, functions, and operation as the duct seal member 31, the thread engaging member 33, and the bracing member 32, respectively, described in more detail above and illustrated in connection with FIG. 1 and FIG. 11A through FIG. 11C.

In operation, the end of the duct (pipe 970) is inserted into (and received by) the connector opening 923a of the casing member 920 and the adjusting connector member 940. In this embodiment, the duct (pipe 970) has a generally cylindrical shape and an outside diameter within a predetermined range. For example, the pipe 970 in some embodiments may have an outside diameter within the range of 0.8 inches to 1.0 inches. In addition, the duct (pipe 970) may have a variety of different thread types (not illustrated) on the end thereof, or no threads at all, as described in more detail above. Thus, the device 915 is capable of connecting to a variety of different types and sizes of ducts (pipe 970). As the duct (pipe 970) is being inserted into (and received by) the device 915, if the outside diameter of the duct (pipe 970) is the minimum acceptable diameter of the duct (pipe 970) the distal end of the duct (pipe 970) may travel down the longitudinal axis of the adjusting connector member 940 with only minimal contact against the portion of the thread engaging member extending through the duct seal member 941b. The duct (pipe 970) is advanced into the device 915 until a portion of the duct seal member 941 has changed shape, and possibly expanded, to conform to and be positioned adjacent to the exterior surface of the duct (pipe 970). In other embodiments, all or any combination of the duct sealing means or the thread engaging means (which are described in more detail above and illustrated in connection with FIG. 11A through FIG. 17B) may be used to hold the pipe 970 operatively in place in the device 915. In embodiments of the device 915 that comprise at least one duct stop member (not illustrated, but similar to the at least one duct stop member 62d described in more detail above and illustrated in connection with FIG. 13), the duct (pipe 970) may be inserted into the device 915 until the duct (pipe 970) open end abuts against the at least one duct stop member. Where the duct (pipe 970) has threads and is large enough to engage the thread engaging member of the adjusting connector member 940, the thread engaging member may engage the threads of the duct (pipe 970) in substantially the same manner as the thread engaging members 33, 43 engage the threads 70a of the duct (pipe 70), as described in more detail above and illustrated in connection with FIG. 11A through FIG. 12C.

With respect to connection to the other duct (bottle spout 975a), the end of the duct (bottle spout 975a) is inserted into (and received by) the connector opening 922a of the casing member 920 and the adjusting connector member 930. In this embodiment, the duct (bottle spout 975a) is the spout of a bottle 975 that may have a variety of different sizes and shapes. The duct (bottle spout 975a) has a generally cylindrical shape and an outside diameter within a predetermined range. For example, the bottle spout 975a in some embodiments may have an outside diameter within the range of 0.8 inches to 1.3 inches. In addition, the duct (bottle spout 975a) may have a variety of different thread types (not illustrated) on the end thereof, or no threads at all, as described in more detail above. Thus, the device 915 is also capable of connecting to a variety of different types and sizes of bottles or other containers having spouts 975a of varying sizes and shapes. As the duct (bottle spout 975a) is being inserted into (and received by) the device 915, if the outside diameter of the duct (bottle spout 975a) is the maximum acceptable diameter of the duct (bottle spout 975a) the distal end of the duct (bottle spout 975) will impinge upon the portion of the thread engaging member of the adjusting connector member 930 extending through the duct seal member 931b. If the duct (bottle spout 975a) has threads, the thread engaging member may engage the threads of the duct (bottle spout 975a) in substantially the same manner as the thread engaging members 33, 43 engage the threads 70a of the duct (pipe 70), as described in more detail above and illustrated in connection with FIG. 11A through FIG. 12C. The duct (bottle spout 975a) also impinges upon the duct seal member 931, and as the duct (bottle spout 975a) is advanced into the device 915, a portion of the duct seal member 941 changes shape, generally expanding radially, to conform to and be positioned adjacent to the exterior surface of the duct (bottle spout 975a). In other embodiments, all or any combination of the duct sealing means or the thread engaging means (which are described in more detail above and illustrated in connection with FIG. 11A through FIG. 17B) may be used to hold the bottle spout 975a operatively in place in the device 915. In embodiments of the device 915 that comprise at least one duct stop member (not illustrated, but similar to the at least one duct stop member 62d described in more detail above and illustrated in connection with FIG. 13), the duct (bottle spout 975a) may be inserted into the device 915 until the duct (bottle spout 975a) open end abuts against the at least one duct stop member. Preferably, once the duct (bottle spout 975a) is in position in the device 915, the duct support members 922g may be deformed radially inward until they are positioned adjacent to a surface of the bottle 975, so that the duct support members 922g together are adapted to hold the bottle 975 in place relative to the device 915 while the duct (bottle spout 975a) is connected to the device 915. In embodiments where the case body connecting section 921i comprises a valve mechanism, as is illustrated in FIG. 19, the valve mechanism may initially be closed, so that fluids do not flow through the casing member 915. Once the ducts (pipe 70 and bottle spout 975a) are connected to the device 915, the valve mechanism may be opened the desired amount to produce the desired rate of fluid flow and is then closed when the desired amount of fluid has been transferred through the device 915. Thus, the user of the device 915 may be provided with more control over fluid flow through the device 915 than other means (such as a funnel or siphon) used to transfer fluids.

Continuing to refer to the embodiment of the device 915 illustrated in FIG. 19, in some cases, supplemental duct sealing means may be utilized to provide or enhance the seal between the duct seal member 931 and the duct (bottle spout 975a). This may be the case where the device 915 may be operating at relatively high pressure, or where only minimal contact may be present between the duct seal member 931 and the exterior surface of the duct (bottle spout 975a) because of minimum duct (bottle spout 975a) size, or where the thread engaging member of the adjusting connector member 930 is not adequate to hold the duct (bottle spout 975a) in place in the device 915. The duct sealing means may include adhesive, glue, epoxy or other joining compound or a combination of such means that is stored in a container or other receptacle, which is then positioned as a film 990 on a portion of the duct sealing means (duct seal member 931) or the duct (bottle spout 975a) or both prior to connecting the duct (bottle spout 975a) to the device 915. The adhesive film 990 may provide for a relatively permanent attachment of the duct seal member 931 to the duct (bottle spout 975a), which is not preferred, so that the duct seal member 931 is not easily removed from the duct (bottle spout 975a). An example of this type of adhesive is Cyanoacrylate(methyl-2-cyanoacrylate), which may be typically sold under the trademark SUPERGLUE. Alternatively, the adhesive film 990 may provide for non-permanent attachment of the duct seal member 931 to the duct (bottle spout 975a), which is preferred, so that the duct seal member 931 is relatively easily removed from the duct (bottle spout 975a) after use of the device 915 is completed. An example is an adhesive similar to rubber cement made from a polymer (such as latex) mixed in a solvent such as acetone, hexane, heptane or benzene to keep the polymer fluid prior to use. In addition, the adhesive film 990 may be comprised of an adhesive layer 990 with a peel-off strip (not illustrated) positioned over the adhesive layer 990, which is removed prior to insertion of the duct (bottle spout 975a) into the device 915. For example, this type of adhesive layer 990 and peel-off strip may be comprised of double coated urethane, vinyl or polyethylene adhesive tapes with release liners, such as those manufactured by the 3M Company.

Thus, referring to the embodiment of the device 15 illustrated in FIG. 1 and FIG. 11A through FIG. 12C as an example, as is apparent from the foregoing description, the preferred type and structure of each of the duct seal members 31, 41, the bracing members 32, 42, the thread engaging members 33, 43, and the adjusting member internal connecting means, as well as other members comprising the device 15, are dependent upon numerous different factors. In addition, the preferred types and structure of the casing member 20, the adjusting connector members 30, 40, and the casing connecting means (which are described in more detail above), are also dependent upon numerous different factors. A device 15 having a particular combination of features appropriate for one type of operating condition may not be appropriate for other types of operating conditions. In addition to the preferences described above, in the case of a device 15 designed for use with room temperature domestic potable water and capable of accommodating pipes 70, 75 in the range of ¾″ to ½″ nominal diameter, the type of casing member 20 described above and illustrated in connection with FIG. 1 is preferred, and the preferred casing connecting means are that which is a part of the adjusting connector member 1040 illustrated in FIG. 20.

The present invention also includes kits (not directly illustrated) that comprise various combinations of components of the present invention, such components being described in more detail elsewhere herein. For example, a kit may comprise two or more adjusting connector members 30, 40, 60, 160, 260, 330, 360, 430, 440, 460, 730, 830, 840, 930, 940, 1040, as described in more detail above and illustrated in connection with FIG. 1, FIG. 5, FIG. 6, and FIG. 10 through FIG. 20, comprising any combination or combinations of any embodiments of such adjusting connector members. In addition, a kit may comprise two or more of the duct sealing means, bracing means, or thread engaging means, as such means are described in more detail above and illustrated in connection with FIG. 1, FIG. 5, FIG. 6, and FIG. 10 through FIG. 20, or any combination or combinations of any embodiments of such duct sealing means, bracing means, or thread engaging means. Further, a kit may comprise one or more adjusting connector members 30, 40, 60, 160, 260, 330, 360, 430, 440, 460, 730, 830, 840, 930, 940, 1040 along with any combination or combinations of any embodiments of one or more of the duct sealing means, bracing means, or thread engaging means, as all are described in more detail above and illustrated in connection with FIG. 1, FIG. 5, FIG. 6, and FIG. 10 through FIG. 20, or any combination or combinations of any embodiments of any of the above. Further still, a kit may comprise two or more casing members 20, 320, 420, 720, 820, 820, 920, 1020, as described in more detail above and illustrated in connection with FIG. 1 through FIG. 10 and FIG. 18 through FIG. 20, in any combination or combinations of any embodiments of such casing members. A kit may also include one or more of the case caps 22, 23, 322, 323, 422, 423, 522, 622, 722, 822, 823, 922, 923, one or more of the case body conduit sections 21′, 21″, 121′, 121″, 221′, 221″, 321′, 321″, 421′, 421″, 721′, 721″, 821′, 821″, 921′, 921″, 1021″, or one or more of the case body connecting sections 21i, 121i, 221i, 321i, 921i, as all are described in more detail above and illustrated in connection with FIG. 1 through FIG. 10 and FIG. 18 through FIG. 20, in any combination or combinations of any embodiments of any of the above with one another. In addition, a kit may comprise one or more casing members 20, 320, 420, 720, 820, 820, 920, 1020, as described in more detail above and illustrated in connection with FIG. 1 through FIG. 10 and FIG. 18 through FIG. 20, in any combination or combinations with any embodiment of one or more of the case caps 22, 23, 322, 323, 422, 423, 522, 622, 722, 822, 823, 922, 923, one or more of the case body conduit sections 21′, 21″, 121′, 121″, 221′, 221″, 321′, 321″, 421′, 421″, 721′, 721″, 821′, 821″, 921′, 921″, 1021″, or one or more of the case body connecting sections 21i, 121i, 221i, 321i, 921i, as all are described in more detail above and illustrated in connection with FIG. 1 through FIG. 10 and FIG. 18 through FIG. 20. Further, a kit may comprise any embodiment or embodiments of one or more adjusting connector members 30, 40, 60, 160, 260, 330, 360, 430, 440, 460, 730, 830, 840, 930, 940, 1040 along with any combination or combinations of any embodiment or embodiments of one or more of the casing members 20, 320, 420, 720, 820, 820, 920, 1020, as all are described in more detail above and illustrated in connection with FIG. 1 through FIG. 20.

Referring to the device 15 illustrated in FIG. 1 as an example, a method of using the device 15 is also disclosed, the method comprising connecting an adjusting connector member (such as adjusting connector member 30) to the casing member 20 using the casing connecting means, which are described in more detail above. In embodiments comprising a case body 21 and a case cap 22, the method may comprise positioning the adjusting connector member 30 adjacent to the case body 21 using the casing connecting means, and then positioning the case cap 22 on the case body 21 using the case cap connecting means. An additional method of operating the device 15 comprises connecting the at least one case body conduit section 21′, 21″ to the at least one case body connecting section 21i using the case body section connecting means (threads 21j, 21, k, 21l illustrated in FIG. 2).

What is claimed is:

1. A device for connecting to a duct comprising a duct open end and a duct exterior surface adjacent to the duct open end having a size and shape adapted to be variable within a predetermined range, the device comprising:
(a) a duct seal member, at least a portion of which is adapted to be positioned adjacent to a portion of the duct exterior surface; and
(b) thread engaging means adapted for drawing the duct down into the duct seal member by engaging any threads on the duct exterior surface, wherein at least a portion of the thread engaging means is positioned between the duct and the duct seal member while the duct is operatively connected to the device.

2. The device of claim 1, wherein:
(a) the duct seal member is comprised of an interior surface facing the duct and an exterior surface facing away from the duct; and
(b) the thread engaging means are comprised of at least one thread engaging tab member, a portion of which extends from the vicinity of the exterior surface of the duct seal member through a corresponding opening in the duct seal member so that such portion is adapted to engage any threads on the duct.

3. The device of claim 1, wherein
(a) the duct seal member is comprised of an interior surface facing the duct and an inlet seal flange portion; and
(b) the thread engaging means are comprised of a thread engaging flange member positioned approximately adjacent to the inlet seal flange portion and at least one thread engaging tab member extending from the thread engaging flange member and adapted to engage any threads on the duct.

4. The device of claim 1, wherein the duct seal member is comprised of an interior surface facing the duct and the thread engaging means are comprised of at least one thread engaging tab member extending from the interior surface of the duct seal member.

5. The device of claim 1, further comprising:
(a) bracing means adapted for operatively holding the duct, the duct seal member, and the thread engaging means in place relative to one another; and
(b) adjusting member internal connecting means for operatively connecting the duct seal member, the bracing means, and the thread engaging means together.

6. The device of claim 1, further comprising a casing member and casing connecting means for operatively connecting the device to the casing member.

7. The device of claim 6, wherein the casing member is comprised of casing connecting means adapted for separately connecting the casing member to the device of claim 1 and to at least one additional such device, so that the device of claim 1 is interchangeable with the at least one additional device in operation with the casing member.

8. A device for connecting to a duct comprising a duct open end and a duct exterior surface adjacent to the duct open end having a size and shape adapted to be variable within a predetermined range, the device comprising:
(a) an adjusting connector member comprised of:
(i) a duct seal member further comprising an inlet seal flange portion and a seal sheath portion, which extends from the inlet seal flange portion and is shaped approximately as an hourglass;
(ii) a bracing member; and
(iii) adjusting member internal connecting means for operatively connecting the duct seal member to the bracing member; and
(b) casing connecting means for operatively connecting the adjusting connector member to a casing member.

9. The device of claim 8, further comprising the casing member.

10. The device of claim 9, wherein the casing member is comprised of casing connecting means adapted for separately connecting the casing member to the adjusting connector member and to at least one additional adjusting connector member, so that the adjusting connector member is interchangeable with the at least one additional adjusting connector member in operation with the casing member.

11. The device of claim 8, wherein the bracing member is comprised of a shell member that is approximately tubular in shape having an inlet open end and an outlet open end, and the duct seal member is positioned within the bracing member with the inlet seal flange portion positioned approximately adjacent to the inlet open end of the bracing member.

12. The device of claim 8, wherein the adjusting connector member is further comprised of a compressible insert positioned between the duct seal member and the bracing member.

13. The device of claim 8, wherein the adjusting connector member is further comprised of thread engaging means adapted for engaging any threads on the duct exterior surface.

14. A device comprising a casing member, which is further comprised of:
(a) a case body conduit section;
(b) a case body connecting section having an interior space; and
(c) case body section connecting means for operatively connecting the case body conduit section to the case body connecting section;
(d) wherein the case body conduit section is adapted to be operatively connected to an adjusting connector member adapted for connecting the case body conduit section to a duct comprising a duct open end and a duct exterior surface adjacent to the duct open end, and the duct exterior surface has a size and shape adapted to be variable within a predetermined range.

15. The device of claim 14, further comprising casing connecting means for permanently or removably connecting the case body conduit section to the adjusting connector member.

16. The device of claim 15, wherein the case body section connecting means are adapted for connecting the case body conduit section to the case body connecting section and separately to at least one additional case body connecting section, so that the case body connecting section is interchangeable with the additional case body connecting section.

17. The device of claim 14, wherein the casing member is further comprised of at least one additional case body conduit section and case body section connecting means for operatively connecting the at least one additional case body conduit section to the case body connecting section.

18. The device of claim 14, wherein the case body conduit section is comprised of a flexible or semi-flexible material.

19. The device of claim 14, further comprising the adjusting connector member.

20. The device of claim 14, wherein the adjusting connector member is further comprised of:
(a) a duct seal member adapted for being positioned adjacent to the duct exterior surface while the duct is connected to the device;
(b) bracing means adapted for operatively holding the duct, the duct seal member, and the thread engaging means in place relative to one another; and
(c) adjusting member internal connecting means for operatively connecting the duct seal member and the bracing means together; and
(d) casing connecting means for operatively connecting the adjusting connector member to the casing member.
